(19) United States
(12) Patent Application Publication
(10) Pub. No.: US 2018/0344556 A1
(43) Pub. Date: Dec. 6, 2018

(54) PATIENT HANDLING APPARATUS AND METHOD

(71) Applicant: David E.T. Garman Concepts Limited, Preston Lancashire (GB)

(72) Inventors: David Edmund Talbot Garman, Llandrindod Wells, Powys (GB); Austin William Owens, Herefordshire (GB)

(21) Appl. No.: 15/777,708

(22) PCT Filed: Mar. 7, 2016
(86) PCT No.: PCT/GB2016/050600

§ 371 Date: May 21, 2018

(30) Foreign Application Priority Data
Nov. 20, 2015 (GB) 1520454.8
Jan. 14, 2016 (GB) PCT/GB2016/050083

(51) Int. Cl. A61G 7/10; A61G 7/02

(52) U.S. Cl. CPC A61G 7/1059; A61G 7/1021; A61G 7/1034; A61G 7/1023; A61G 7/02

(57) ABSTRACT

A soft-walled inflatable cradle (10) has a seat section (14), a back-support section (16), and a pair of opposed side panel sections (18, 20) extending between respective sides of the back-support and the seat. The cradle is positioned about a patient in an un-inflated condition and inflated to define a self-supporting seat structure. The cradle may be formed in at least two separable parts which can be positioned about a patient and connected together prior to inflation. The cradle may be used in co-operation with apparatus which include rollers over which the inflated cradle is moved. Methods of handling a patient using the cradle are also disclosed.

### TECHNICAL FIELD OF THE INVENTION

The present invention relates to patient handling. The invention relates in particular to apparatus and methods for moving a patient and especially, but not exclusively, to apparatus and methods for transferring a disabled, elderly and/or infirm person.

### BACKGROUND TO THE INVENTION

People who are severely ill, elderly, disabled or otherwise infirm may lose the ability to move freely on their own and require assistance for repositioning and movement. This is a particular issue for people who have insufficient upper body strength to support themselves in an upright sitting position without assistance and for people who are very heavy, such as bariatric patients. The responsibility for assisting such people falls to care providers who reposition patients to prevent pressure ulcers and promote comfort and who transfer patients between supporting structures, such as between beds, chairs, wheelchairs or patient trolleys for example. In some situations, a person must be transferred vertically, say between equipment with support surfaces of different heights. In other cases, the transfer is predominantly in a lateral or otherwise generally horizontal direction. This might be the case where a patient is repositioned on a bed or is transferred between adjacent surfaces at the same height, such as between a bed and an adjacent patient trolley, or between a chair and a commode, for example.

Research has shown that care providers experience significant physical stress when performing manual lifting and repositioning tasks which can lead to physical injury, including musculoskeletal disorders that can cause chronic back pain. Manual handling is also undesirable for the patient who is at risk of pain and discomfort, skin tears, bruising and being dropped, as well as suffering indignity. One of the highest risk manual handling activities is transferring a patient on or off a bed. This often requires the care provider to reach across the bed adopting a bad posture which can result in high physical stress to their body, particularly their back. The relatively soft nature of bed mattresses adds to the difficulty as they tend to compress when a force is applied, making it more difficult to move a patient safely and efficiently.

To alleviate the problems outlined above, various apparatus and methods have been developed over the years. Technologies to assist with vertical transfer of patients include powered full-body sling lifts, floor-based lifts, ceiling- mounted lifts, powered standing lifts, non-powered standing aids and gait/transfer belts. Technologies to assist with horizontal/lateral transfer and repositioning of patients include air-assisted systems, friction-reducing devices such as glide sheets, mechanical lateral transfer aids, sliding boards and transfer chairs.

The apparatus developed so far have significant drawbacks. Glide sheets are easily positionable beneath a patient lying on a surface using the so-called “log roll” technique in which the patient is first rolled over to one side and then to the other to enable the sheet to be manoeuvred into position. However, they offer little support to the patient who may feel vulnerable during transfer. For patients who are unable to sit-up unaided, glide sheets are generally used with the patient lying supine and so are of limited use in transferring such a patient where they must be moved between lying and sitting positions. Whilst glide sheets reduce friction between the patient and the surface on which they are lying or sitting, they still often require significant force to be applied to manually move the patient. Transfer boards are useful for transferring a patient in a sitting position but are of limited use for patients who have insufficient upper body strength to support themselves unaided in an upright sitting position.

Other types of apparatus require the patient to be manually lifted when positioning them on the equipment. This can be especially problematic when the patient is on a bed due to the soft nature of the bed mattress and the difficulty in reaching a patient positioned centrally within a bed.

Powered lifting aids such as lifts and hoists are often expensive, heavy and bulky. Ceiling-mounted lifts operate on a fixed run and so do not offer flexibility of use. Mobile hoists tend to be large and difficult to manoeuvre and so are not always able to be used where access is limited. Storage of mobile hoists can also be problematic. Hoists and lifts are used with slings which must be carefully selected to suit the particular patient and also regularly cleaned and disinfected and, on occasion, disposed of altogether. A further issue with powered lifting aids is that they require significant training to use safely and competently.

There is therefore a need for an improved apparatus for handling a patient which overcomes, or at least mitigates, the drawbacks of the known apparatus.

There is also a need for an improved method of handling a patient which overcomes, or at least mitigates, the drawbacks of the known methods.

### SUMMARY OF THE INVENTION

In accordance with a first aspect of the invention, there is provided a method of handling a patient using apparatus including an inflatable patient transfer cradle, the cradle when inflated defining a self-supporting seat structure capable of holding a patient seated in the inflated cradle in an upright sitting position for transfer between different locations; the cradle having an inflatable seat section, an inflatable back-support section, and a pair of opposed inflatable side panel sections, each inflatable section comprising a soft-walled inflatable body which is flexible when un-inflated; the method comprising:

a. positioning the un-inflated cradle about a patient with the seat section located beneath the patient's upper thigh/buttock region and the back-support section about the patient's back;

b. subsequently inflating the cradle to define said seat structure about the patient.

In an embodiment, the cradle is configured so that when inflated to define said seat structure and in an upright position, the back-support section extends upwardly from the seat section with the side panel sections extending between and connected to the back-support section and the seat section on respective sides to define with the back-support section a volume within which the upper body of a patient sitting on the seat section is supported and held generally upright by the back-support section and the side panel sections, the side panel sections being operative to hold the back-support section extending upwardly from the seat section in a self-supporting manner.

In the method of the first aspect, the un-inflated cradle may be positioned about a patient sitting upright on a supporting surface, the seat section being located between the patient's upper thigh/buttock region and the supporting surface, the patient's upper thigh/buttock region being lifted above the surface as the seat section is subsequently inflated.

In an alternative embodiment, the un-inflated cradle is positioned about a patient lying on a supporting surface, the method comprising:

a. positioning the un-inflated seat section and back-support section between the patient and the supporting surface on which they are lying and placing the patient in a supine position with the back-support section located beneath the patient's back and the seat section located beneath the patient's upper thighs;

b. subsequently inflating the cradle such that the patient is drawn into a sitting position as the cradle inflates to define said seat structure.

The seat section, the back-support section and the side panel sections may each have an inner surface which is directed toward a patient when sitting in the inflated cradle in use and an opposing outer surface which is directed away from the patient, in which case the step of positioning the un-inflated seat section and back-support section between the patient and the supporting surface on which they are lying may comprise positioning the seat section and the back-support section extending generally in a common plane on the supporting surface with their outer surfaces directed toward the supporting surface, the inner surface of the seat structure beneath and facing the patient's upper thigh/buttock region, and the inner surface of the back-support section beneath and facing the patient's back; the seat section and the back-support section being drawn into a configuration in which they extend at an angle to one another when the cradle is subsequently inflated to define said seat structure, with the inner surface of the back-support section being directed toward and supporting the patient's back. The seat section and the back-support section may be drawn into a configuration in which their inner surfaces extend at an angle in the range of 85 to 130 degrees, or more particularly at an angle in the range of 89 to 110 degrees, relative to one another to define said seat structure.

In an embodiment, the method comprises inflating the cradle such that the outer surface of the back-support section remains in contact with the supporting surface and the seat section is drawn into a position in which its inner and outer surfaces extend generally upwardly from the supporting surface as the cradle is inflated to define said seat structure, the method further comprising tipping the inflated cradle with the patient on-board forwardly on to the outer surface of the seat section so as to raise the back-support section off the supporting surface and place the patient in an upright sitting position supported in the inflated cradle.

Alternatively, the method may comprise holding the outer surface of the seat section in contact with the supporting surface as the cradle is inflated such that the outer surface of the back-support section is drawn off the supporting surface to automatically raise the patient into an upright sitting position as the cradle inflates to define the seat structure. The apparatus may further comprise a lower leg support releasably attachable to the cradle so as to extend forwardly from the seat section and the method may comprise attaching the lower leg support to the cradle and supporting the patient's leg(s) on the lower leg support before the cradle is inflated such that the weight applied to the lower leg support holds the outer surface of the seat section in contact with the supporting surface as the cradle is inflated.

In an embodiment, each side panel section is releasably attachable to at least one of the seat section and the back-support section, and the step of positioning the un-inflated cradle about the patient is carried out with the cradle in an un-assembled configuration in which at least one side panel section is disconnected from at least one of the seat section and the back-support section;

the un-inflated cradle subsequently being placed in an assembled configuration in which each side panel is connected to both the seat section and the back-support section prior to the step of inflating the cradle. Both side panel sections may be disconnected from at least one of the seat section and the back-support section when the cradle is in its un-assembled configuration for positioning about the patient.

Each side panel section may be releasably attachable to both the seat section and the back-support section and at least one side panel may be disconnected from both the seat section and the back-support section when the cradle is in its un-assembled configuration for positioning about the patient. If desired, both side panel sections may be disconnected from the seat section and the back-support section when the cradle is in its un-assembled configuration for positioning about the patient.

In an embodiment, the seat section is hingedly connected to the back- support section. In an alternative embodiment, the seat section is not directly attached to the back-support section and is connected to the back-support section only via the side panel sections. In a still further embodiment, the seat section is releasably attachable directly to the back-support section.

In an embodiment, the cradle has at least two separable parts releasably attachable to one another, the at least two separable parts including a first part comprising at least the back-support section and a second part comprising at least the seat section, each side panel section extending between and connected to the back-support section and a respective side of the seat section when the at least two parts are assembled; and the step of positioning the un-inflated cradle about a patient comprises positioning the un-inflated cradle about the patient with the at least two parts separated and subsequently connecting the at least two parts together prior to the step of inflating the cradle.

In an embodiment, the step of positioning the un-inflated cradle about a patient may comprise positioning the seat section and the back-support section between a patient and a surface on which they are lying and placing the patient in a supine position such that the back-support section is located beneath and its inner surface directed towards the patient's back and the seat section is located beneath the patient's upper thighs and connecting the at least two parts of the cradle together whilst the patient remains in a supine position prior to the step of inflating the cradle.

The seat section may be profiled to define a central recess along a rear edge, and the step of positioning the seat section and the back-support section about a patient may comprise positioning the rear edge of the seat section about the patient's buttock region so that at least part of the patient's buttock/hip region is located in the recess for contact with the supporting surface prior to inflation of the cradle.

The back-support section may be profiled to define a central recess along a bottom edge, and the step of positioning the back-support section and the seat section about a patient may comprise positioning the bottom edge of the back-support section about the patient's buttock region so that at least part of the patient's buttock/hip region is located in the recess for contact with the supporting surface prior to inflation of the cradle.

In an embodiment, the cradle is inflated to a pressure of at least 27 kPa or at least 34 kPa.

With a patient supported in the inflated cradle and the cradle in an upright position, the method may comprise manoeuvring the inflated cradle with a patient on-board across a surface.

The method may comprise:

a. supporting a patient in the inflated cradle in an upright sitting position on a first supporting structure;

b. moving the cradle from the first supporting structure onto a second supporting structure whilst the patient is supported in an upright sitting position within the inflatable cradle during said movement.

The apparatus may further comprise a roller transfer assembly comprising a supporting structure in which are mounted a plurality of rollers, and the method may comprise positioning the roller transfer assembly on a surface, positioning the inflated cradle with a patient on-board on the roller transfer assembly so that the seat section is supported on the rollers of the roller transfer assembly and moving the cradle with the patient on-board along the roller transfer assembly across the rollers.

The apparatus may further comprise a mobile transfer unit, the mobile transfer unit comprising a chassis with rotatable ground-engaging members for movement over a floor surface and a height-adjustable platform defining a support surface, a plurality of rollers mounted to the platform in association with the support surface; and the method may comprise manoeuvring the inflated cradle with a patient on-board on or off the platform of the mobile transfer unit by rolling the seat section of the inflated cradle across the rollers mounted in the platform.

Where the apparatus includes a mobile transfer unit and a roller transfer assembly, the method may comprise positioning the mobile transfer unit adjacent a supporting surface on which the roller transfer assembly is located with the rollers in the mobile transfer unit platform generally aligned with the rollers in the roller transfer assembly, adjusting the height of the platform to bring the upper surfaces of the rollers on the mobile transfer unit substantially into the same plane as the rollers of the roller transfer assembly, and manoeuvring the inflatable cradle with the patient on-board between the roller transfer assembly and the mobile transfer unit with the seat section rolling across the rollers in the roller transfer assembly and the rollers in the platform of the mobile transfer unit.

The apparatus may include a chair comprising a seat defining a seating surface, a plurality of rollers mounted in the seat, and the method may comprise manoeuvring the inflated cradle with a patient on-board on or off the seating surface by rolling the seat section of the inflated cradle across the rollers mounted in the platform. The rollers in the seat may be provided in a plurality of roller batons, each roller baton comprising an elongate support member to which are rotatably mounted a plurality of said rollers, the roller batons extending in a transverse direction across the seat. In an embodiment, the roller batons are mounted in recesses in the seat and the chair can be adjusted between a transfer configuration in which at least the upper surfaces of the rollers are positioned above the seating surface and non-transfer configuration in which the rollers are located wholly below the seating surface, and the method may comprise placing the chair in the transfer configuration for use in manoeuvring the inflated cradle with a patient on-board on to the chair and placing the chair in a non-transfer configuration once the cradle is located above the seating surface so that the seat section is supported on the seating surface.

The apparatus may include a toileting support comprising a seat having a toileting aperture and at least one roller mounted within or adjacent the seat, the upper surface of the at least one roller being positionable just above an upper surface of the seat and the method may comprise manoeuvring the inflated cradle with a patient on-board on or off the toileting support by rolling the seat section of the inflated cradle across the at least one roller mounted within or adjacent the seat. In an embodiment, the at least one roller mounted within or adjacent the seat of the toileting support includes a transverse elongate roller assembly mounted transversely across the seat in front of the toileting aperture, the transverse elongate roller assembly comprising a roller baton having an elongate support member to which are mounted a plurality of rollers. In an embodiment, toileting support is adjustable between a transfer configuration in which at least the upper surfaces of the rollers are positioned above the upper surface of the seat and a non-transfer configuration in which the rollers are wholly located below the upper surface of the seat, and the method comprises placing the toileting support in the transfer configuration when manoeuvring the inflated cradle with a patient on-board on to the toileting support and placing it in a non-transfer configuration once the cradle is located above the seat.

The apparatus may include a floor-lift device comprising a frame having raised side bars interconnected by a number of rigid cross-members, the cross-members angling downwardly from each of the side bars to a central region in which they extend generally horizontally to define a recessed base region, a plurality of rolling ground-engaging members mounted to the frame so that the device can be rolled along the ground or floor and a soft-walled inflatable member positioned on the base region; in which case where the surface on which the patient is lying is a floor and the cradle is inflated with the back-support section remaining in contact with the floor, the method may comprise positioning the floor-lift device on the floor in front of the seat section of the inflated cradle with the inflatable member un-inflated and tipping the cradle forwardly so that the seat section comes to rest and is supported on top of the inflatable member on the base region. The method may also comprise subsequently inflating the inflatable member to raise the inflated cradle with the patient on-board.

In accordance with a second aspect of the invention, there is provided apparatus for use in the method according to the first aspect, the apparatus comprising an inflatable patient transfer cradle which when inflated defines a self-supporting seat structure capable of holding a patient seated in the inflated cradle in an upright sitting position for transfer between different locations; the cradle comprising an inflatable seat section, an inflatable back-support section, and a pair of opposed inflatable side panel sections, each inflatable section comprising a soft-walled inflatable body which is flexible when un-inflated.

In an embodiment, the cradle is configured such that when inflated to define said seat structure and placed in an upright position on the seat section, the back-support section extends upwardly from the seat section with the side panel sections extending between and connected to the back-support section and the seat section on respective sides to define with the back-support section a volume within which the upper body of a patient sitting on the seat section is supported and held generally upright by the back-support section and the side panel sections, the side panel sections being operative in use to hold the back- support section extending upwardly from the seat section to support the weight of a patient's upper body in a self-supporting manner.

Each side panel section may be releasably attachable to at least one of the seat section and the back-support section. Each side panel section may be releasably attachable to both the seat section and the back-support section. The cradle may have a plurality of releasable fasteners for releasably attaching each side panel section to said at least one of the seat section and the back-support section.

The seat section may be permanently and hingedly connected to the back-support section. Alternatively, the seat and back-support sections may not be directly connected and only attached to one another through the side panel sections when the cradle is assembled.

In an embodiment, the cradle has at least two separable parts releasably attachable to one another, a first part comprising at least the back-support section and a second part comprising at least the seat section, each side panel section extending between and connected to the back-support section and a respective side edge of the seat section when the at least two parts are assembled.

The side panel sections may be permanently attached to one of the seat section and the back-support section and releasably connectable to the other of the seat section and the back-support section to attach the first and second parts together, the cradle comprising a plurality of releasable fasteners for releasably connecting each side panel section to said other of the seat section and the back-support section. The side panel sections may be permanently attached to opposed sides of the seat section and releasably attachable to the back-support section or the side panel sections may be permanently attached to opposed sides of the back-support section and releasably attachable to the seat section.

Each of the side panel sections may be releasably attachable to the seat section and to the back-support section, the cradle having on either side a first plurality of releasable fasteners for connecting a respective side panel section to the seat section and a second plurality of fasteners for connecting the respective side panel section to the back-support section.

The cradle may be configured to be inflated to a pressure of at least 27 kPa or at least 34 kPa.

The seat section may be profiled to define a central recess along a rear edge of the seat section.

The back-support section may be profiled to define a central recess along a bottom edge.

The seat section may define a toileting aperture.

The interior of at least one of the seat section, the back-support section, and each of the side panel sections may be fluidly connected to the interior of at least one other of the seat section, the back-support section, and each of the side panel sections by an external fluid connection having a releasable coupling.

The interiors of the seat section, the back-support section, and each of the side panel sections may be fluidly interconnected by external fluid connections, each fluid connection comprising a fluid coupling having inter-engageable male and female coupling parts.

The cradle may have at least one safety restraint to retain a patient in the inflated cradle. The restraint may be releasably attachable across the front of the cradle between the side panel sections. The at least one safety restraint may comprise a strap secured to one of the side panel sections and having a free end releasably attachable to the other side panel section by means of a buckle or other fastening.

The apparatus may further comprise a roller transfer assembly, the roller transfer assembly having a supporting structure in which are mounted a plurality of rollers. The roller transfer assembly may have a plurality of roller batons aligned parallel to one another, each roller baton comprising an elongate support member to which are rotatably mounted a plurality of rollers. The roller batons may be spaced from one another.

The roller transfer assembly may comprise a first set of rollers mounted to the supporting structure for rotation about axes which extend parallel to one another in a first direction and which have upper surfaces aligned in a first plane, and a second set of rollers mounted to the supporting structure for rotation about axes which extend parallel to one another in a second direction different from the first, the rollers in the second set having upper surfaces which are aligned in a second plane; the roller transfer assembly being movable between a first configuration in which the upper surfaces of the rollers in the first set are located above the upper surfaces of the rollers in the second set and a second configuration in which the upper surfaces of the rollers in the first set are located below the upper surfaces of the rollers in the second set. One of the sets of rollers may be movably mountable to the supporting structure between a raised position and a lowered position relative to the supporting structure to move the assembly between said first and second configurations and the assembly may include a mechanism for selectively raising and lowering said one set of rollers. The rollers may be mounted in elongate roller batons, and batons supporting said one set of rollers may be mounted to the supporting structure for movement between raised and lowered positions.

The apparatus may further comprise a mobile transfer unit, the mobile transfer unit having a chassis with rotatable ground-engaging members for movement over a floor surface and a height-adjustable platform defining a support surface, a plurality of rollers mounted to the platform in association with the support surface. The mobile transfer unit may be adjustable between a transfer configuration in which at least the upper surfaces of the rollers are positioned above the support surface and a non-transfer configuration in which the rollers are located wholly below the support surface. The rollers mounted to the platform may be provided in a plurality of roller batons, each roller baton comprising an elongate support member to which are rotatably mounted a plurality of said rollers, the roller batons extending in a transverse direction of the support surface. The rollers may be located in recesses in the platform so that at least the upper surfaces of the rollers are positioned above the support surface. Where the rollers are mounted in roller batons, the roller batons may be adjustably mounted in the platform for movement between a raised, transfer position in which at least the upper surfaces of the rollers are positioned above the support surface and a lowered, non-transfer position in which the rollers are located wholly below the support surface.

The apparatus may further comprise a chair, the chair having a seat defining a seating surface, a plurality of rollers mounted in the seat. The rollers mounted to the seat may be provided in a plurality of roller batons, each roller baton comprising an elongate support member to which are rotatably mounted a plurality of said rollers, the roller batons extending in a transverse direction across the seat. The roller batons may be mounted in recesses in the seat. In an embodiment, the chair can be adjusted between a transfer configuration in which at least the upper surfaces of the rollers are positioned above the seating surface and non-transfer configuration in which the rollers are located wholly below the seating surface. Where the rollers are mounted in roller batons, the roller batons may be adjustably mounted for movement between a raised, transfer position in which at least the upper surfaces of the rollers are positioned above the seating surface and a lowered, non-transfer position in which the rollers are located wholly below the seating surface.

The apparatus may further comprise a toileting support, the toileting support comprising a seat having a toileting aperture and at least one roller mounted within or adjacent the seat, the upper surface of the at least one roller being positioned or positionable just above an upper surface of the seat. The at least one roller may include a longitudinal elongate roller assembly mounted along one side of the seat. The at least one roller may include a transverse elongate roller assembly mounted transversely across the seat. Where present, the transverse elongate roller assembly may comprise a roller baton having an elongate support member to which are mounted a plurality of rollers. In an embodiment, the toileting support is adjustable between a transfer configuration in which at least the upper surfaces of the rollers are positioned above the upper surface of the seat and a non-transfer configuration in which the rollers are wholly located below the upper surface of the seat. Where present, the roller baton may be adjustable between a raised position in which at least the upper surfaces of the rollers are positioned above the upper surface of the seat and a lowered position in which the rollers are wholly located below the upper surface of the seat.

The apparatus may further comprise a floor-lift device, the floor-lift device comprising a frame having raised side bars interconnected by a number of rigid cross-members, the cross-members angling downwardly from each of the side bars to a central region in which they extend generally horizontally to define a recessed base region, a plurality of rolling ground-engaging members mounted to the frame so that the device can be rolled along the ground or floor and a soft-walled inflatable member positioned on the base region. The inflatable member may be in the form of a square-sided ring having a plurality of inflatable sections mounted one above the other.

In accordance with a third aspect of the invention, there is provided use of apparatus in accordance with the second aspect of the invention in the method according to the first aspect of the invention.

In accordance with a fourth aspect of the invention, there is provided a roller transfer assembly comprising a supporting structure in which are mounted a plurality of rollers arranged in rows. The roller transfer assembly may comprise a plurality of roller batons aligned parallel to one another, each roller baton comprising an elongate support member to which are rotatably mounted a plurality of rollers. The elongate support member may comprise a channel member, the rollers being mounted between opposed walls of the channel member. The roller batons may be spaced from one another and interconnected by at least one rigid cross-member. The roller transfer assembly may comprise a first set of rollers mounted to the supporting structure for rotation about axes which extend parallel to one another in a first direction and which have upper surfaces aligned in a first plane, and a second set of rollers mounted to the supporting structure for rotation about axes which extend parallel to one another in a second direction different from the first, the rollers in the second set having upper surfaces which are aligned in a second plane; the roller transfer assembly being movable between a first configuration in which the upper surfaces of the rollers in the first set are located above the upper surfaces of the rollers in the second set and a second configuration in which the upper surfaces of the rollers in the first set are located below the upper surfaces of the rollers in the second set. One of the sets of rollers may be mounted to the supporting structure for movement between a raised position and a lowered position relative to the supporting structure to move the assembly between said first and second configurations and the assembly may include a mechanism for selectively raising and lowering said one set of rollers. The rollers may be mounted in elongate roller batons and the batons supporting said one set of rollers may be mounted to the supporting structure for movement between raised and lowered positions.

The roller transfer assembly may comprise one or more elongate articulated members releasably attachable to the supporting structure, each member comprising a plurality of segments pivotally connected to one another along its length for pivotal movement relative to one another about axes extending transversely to the longitudinal axis of the member, each segment having at least one roller mounted to it for rotation about an axis extending transversely to the longitudinal axis of the member and parallel to axes of rotation between adjacent segments. Each member may have a proximal end for attachment to the supporting structure and an opposite distal end and at least one roller located towards the distal end may have a smaller diameter than at least one roller located toward the proximal end.

In accordance with a fifth aspect of the invention, there is provided a mobile transfer unit, the mobile transfer unit having a chassis with rotatable ground-engaging members for movement over a floor surface and a height-adjustable platform defining a support surface, a plurality of rollers mounted to the platform in association with the support surface. The rollers mounted to the platform may be provided in a plurality of roller batons, each roller baton comprising an elongate support member to which are rotatably mounted a plurality of said rollers, the roller batons extending in a transverse direction of the support surface. The rollers may be located in recesses in the platform so that at least the upper surfaces of the rollers are positioned above the support surface. The mobile transfer unit may be adjustable between a transfer configuration in which at least the upper surfaces of the rollers are positioned above the support surface and a non-transfer configuration in which the rollers are located wholly below the support surface. Where present, the roller batons may be adjustably mounted in the platform for movement between a raised, transfer position in which at least the upper surfaces of the rollers are positioned above the support surface and a lowered, non-transfer position in which the rollers are located wholly below the support surface.

In accordance with a sixth aspect of the invention, there is provided a chair having a seat defining a seating surface and a plurality of rollers mounted in the seat. Each roller may be rotatable about an axis extending in a longitudinal direction of the seat. The rollers mounted to the seat may be provided in a plurality of roller batons, each roller baton comprising an elongate support member to which are rotatably mounted a plurality of said rollers. The roller batons may extend in a transverse direction across the seat. The roller batons may be mounted in recesses in the seat. In an embodiment, the chair can be adjusted between a transfer configuration in which at least the upper surfaces of the rollers are positioned above the seating surface and non-transfer configuration in which the rollers are located wholly below the seating surface. Where present, the roller batons may be adjustably mounted for movement between a raised, transfer position in which at least the upper surfaces of the rollers are positioned above the seating surface and a lowered, non-transfer position in which the rollers are located wholly below the seating surface.

In accordance with a seventh aspect of the invention, there is provided a toileting support, the toileting support comprising a seat having a toileting aperture and at least one roller mounted within or adjacent the seat, the upper surface of the at least one roller being positioned or positionable just above an upper surface of the seat. The at least one roller may include a longitudinal elongate roller assembly mounted along one side of the seat. The at least one roller may include a transverse elongate roller assembly mounted transversely across the seat. The transverse elongate roller assembly may be mounted in front of the toileting aperture. Where present, the transverse elongate roller assembly may comprise a roller baton having an elongate support member to which are mounted a plurality of rollers. In an embodiment, the toileting support is adjustable between a transfer configuration in which at least the upper surfaces of the rollers are positioned above the upper surface of the seat and a non-transfer configuration in which the rollers are wholly located below the upper surface of the seat. Where present, the roller baton may be adjustable between a raised position in which at least the upper surfaces of the rollers are positioned above the upper surface of the seat and a lowered position in which the rollers are wholly located below the upper surface of the seat.

In accordance with an eighth aspect of the invention, there is provided a floor-lift device, the floor-lift device comprising a frame having raised side bars interconnected by a number of rigid cross-members, the cross-members angling downwardly from each of the side bars to a central region in which they extend generally horizontally to define a recessed base region, a plurality of rolling ground-engaging members mounted to the frame so that the device can be rolled along the ground or floor and a soft-walled inflatable member positioned on the base region. The inflatable member may be in the form of a square-sided ring having a plurality of inflatable sections mounted one above the other.

In accordance with a ninth aspect of the invention, there is provided an adjustable roller baton assembly, the assembly comprising at least one roller baton having an elongate support member to which are rotatably mounted a plurality of said rollers and a framework mountable to a supporting structure, the at least one roller baton being mounted to the framework for movement between a raised position and a lowered position, the assembly further comprising a mechanism for moving the at least one roller baton between said raised and lowered positions. The at least one roller baton assembly may be mounted to the framework by means of a plurality of links, each link being pivotally connected with the roller baton and with the framework.

In accordance with a tenth aspect of the invention, there is provided an adjustable roller seating assembly, the assembly comprising a supporting structure, a plurality of rollers mounted to the supporting structure and at least one seat member mounted to the supporting structure, the assembly being movable between a first configuration in which the upper surfaces of the rollers are located above the upper surface of the seat member and a second configuration in which the upper surfaces of the rollers are located below the upper surface of the seat member and a mechanism for moving the assembly between the first and second configurations. The rollers may be mounted in a plurality of elongate roller batons spaced apart with a seat member or portions of a seat member located between the roller batons.

In an adjustable roller baton according to either of the ninth and tenth aspects of the invention, the mechanism may be a winding mechanism comprising a winding bar rotatably mounted to the framework, a handle for rotating the winding bar and a flexible strap connected with the at least one roller baton at one end and with the winding bar at the other. Alternatively, the mechanism may comprise a ratchet-operated screw member.

In accordance with an eleventh aspect of the invention, there is provided an inflatable cradle for supporting a patient in a sitting position, the cradle comprising an inflatable seat section, an inflatable back-support section, and a pair of opposed inflatable side panel sections, each side panel section extending between the back-support and a respective side of the seat, each of the seat, back-support, and side panel sections comprising a soft-walled inflatable structure.

The cradle forms a self-supporting seat structure when inflated, in which the side panel sections are connected between the seat section and the back-support section to hold the back-support section extending generally upright from the seat section so as to support the weight of a patient's torso when the patient is seated in the inflated cradle independently of any external support for the back-support section in use. The cradle may be configured for use with an adult patient weighing 95 kg or more and for use with a bariatric patient.

When un-inflated, each of the seat, back-support, and side panel sections may comprise a thin, flexible structure. Each of the seat, back-support, and side panel sections may be made from a flexible fabric which is impervious to air, such as polyurethane-coated nylon fabric. Each of the seat, back-support, and side panel sections may define a panel-like member which is relatively rigid when inflated in comparison with its un-inflated state. All the structural parts of the cradle which support a patient may be soft-walled inflatable members.

The cradle may comprise at least two parts releasably attachable to one another, a first part comprising at least the back-support section and a second part comprising at least the seat section. The side panel sections may be permanently attached to one of the seat section and the back-support section and releasably connectable to the other of the seat section and the back-support section to attach the first and second parts together. The cradle may comprise a plurality of releasable fasteners for releasably connecting each side panel section to said other of the seat section and the back-support section. Each side panel section may be hingedly connected to a respective side of said one of the seat section and back-support section. In an embodiment, the side panel sections are permanently attached to the seat section and are releasably attachable to the back- support section. In an alternative embodiment, the side panel sections are permanently attached to the back-support section and are releasably attachable to the seat section.

In accordance with a twelfth aspect of the invention, there is provided a method of handling a patient, the method comprising supporting a patient in a sitting position in a cradle in accordance with the eleventh aspect of the invention when the cradle is inflated and manoeuvring the inflated cradle with the patient on-board. The cradle may be manoeuvred across a surface or between adjacent supporting structures.

For the avoidance of doubt, it should be understood that the term “patient” is used herein in a general context to refer to any person who requires assistance in moving and it should be recognised that the patient handling system and methods as described and claimed are not limited to use in a hospital or other formal medical or care facility and could be equally used in a person's private home or indeed any other setting.

### DETAILED DESCRIPTION OF THE INVENTION

Several embodiments of the invention will now be described, by way of example only, with reference to the accompanying drawings, in which:

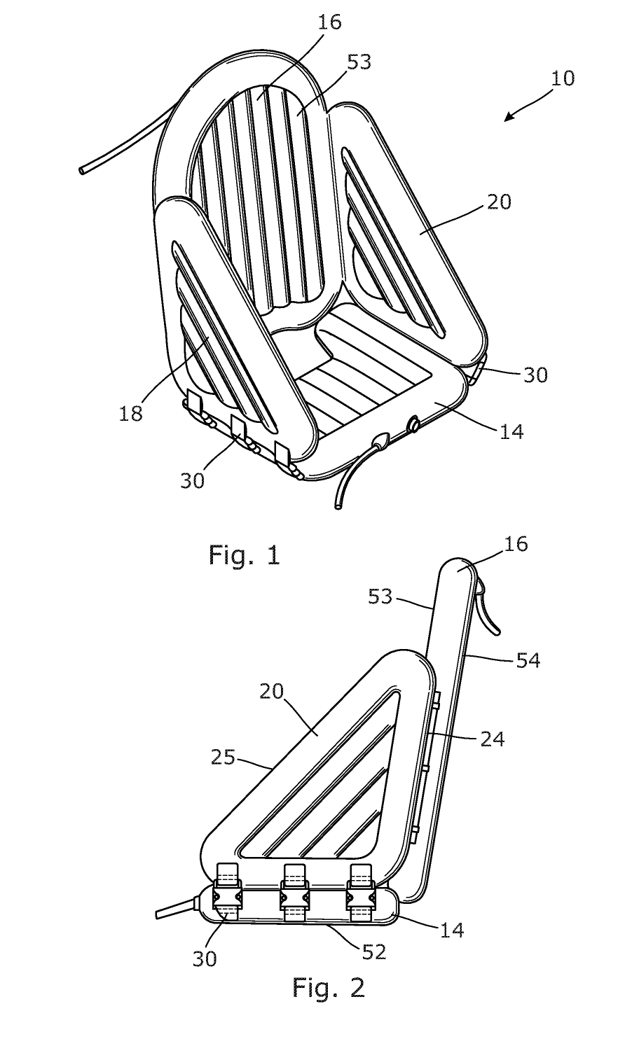

FIG. 1 is a perspective view showing a first embodiment of an inflatable patient cradle which can be used as part of apparatus for handling a patient in accordance with the present invention, showing the cradle inflated;

FIG. 2 is a view from the side of the cradle of FIG. 1;

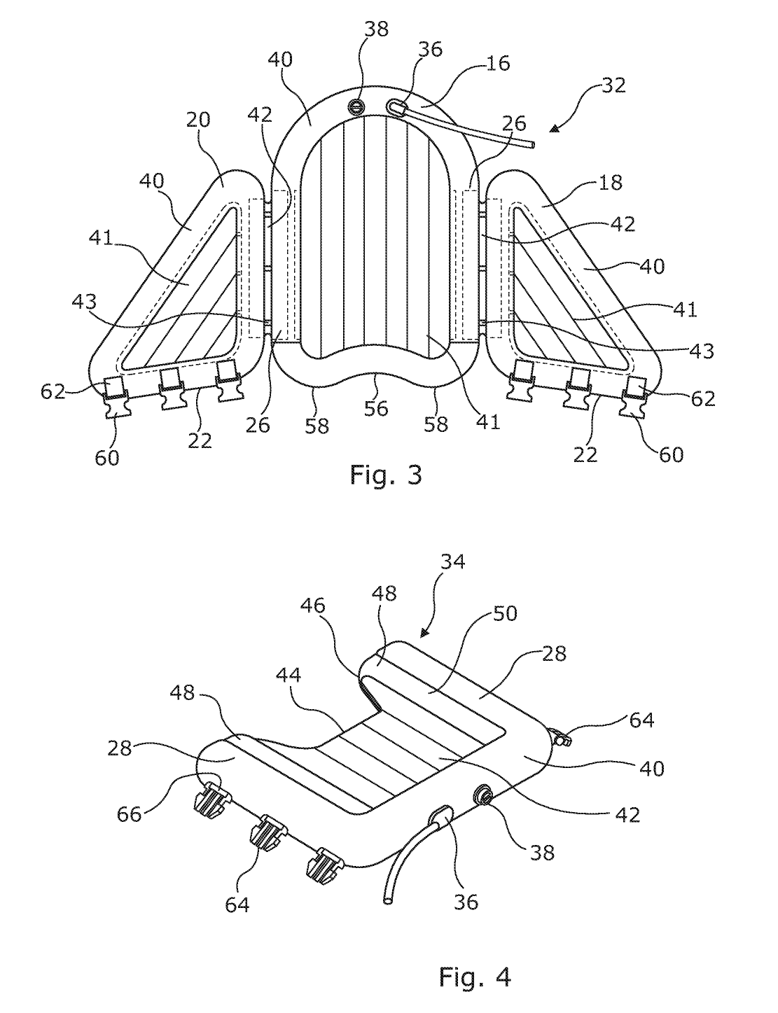

FIG. 3 is a view from the rear of a back-support section and integral side panel sections forming a first part of the cradle of FIG. 1;

FIG. 4 is a perspective view of a seat section forming a second part of the cradle of FIG. 1;

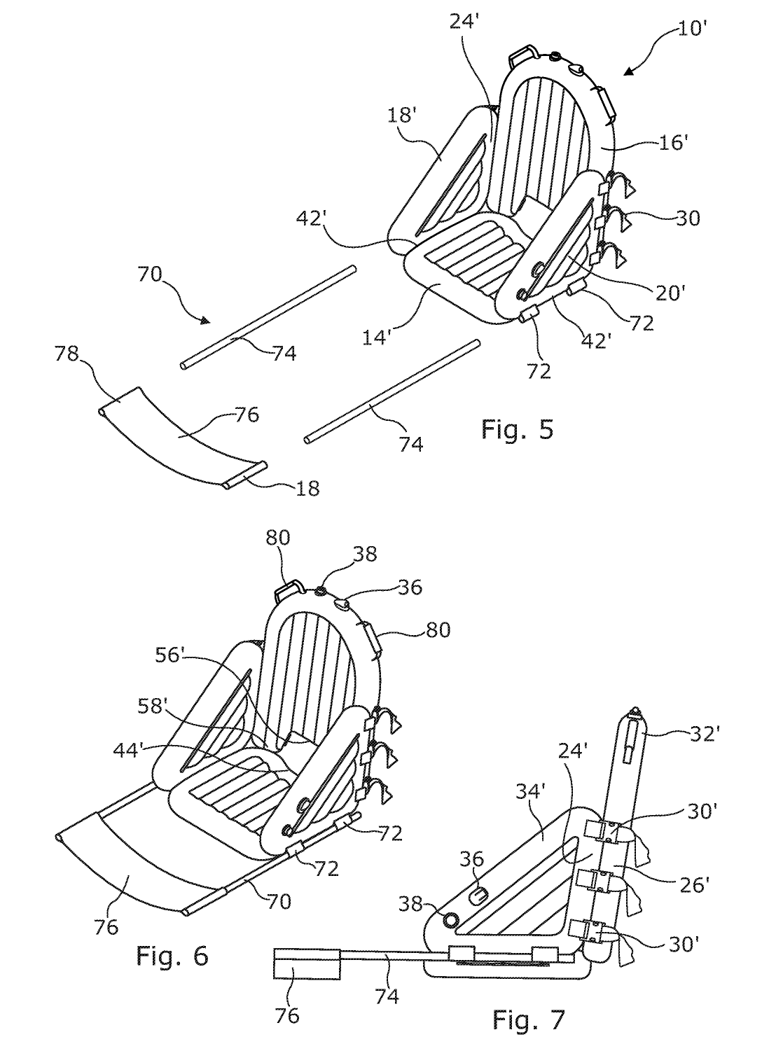

FIG. 5 is a perspective view of a second embodiment of an inflatable patient cradle which can be used as part of apparatus for handling a patient in accordance with the present invention but also showing elements of an associated lower leg support shown in exploded view;

FIG. 6 is a view similar to that of FIG. 5 but showing the lower leg support mounted to the cradle;

FIG. 7 is a view from the side of the cradle of FIG. 6;

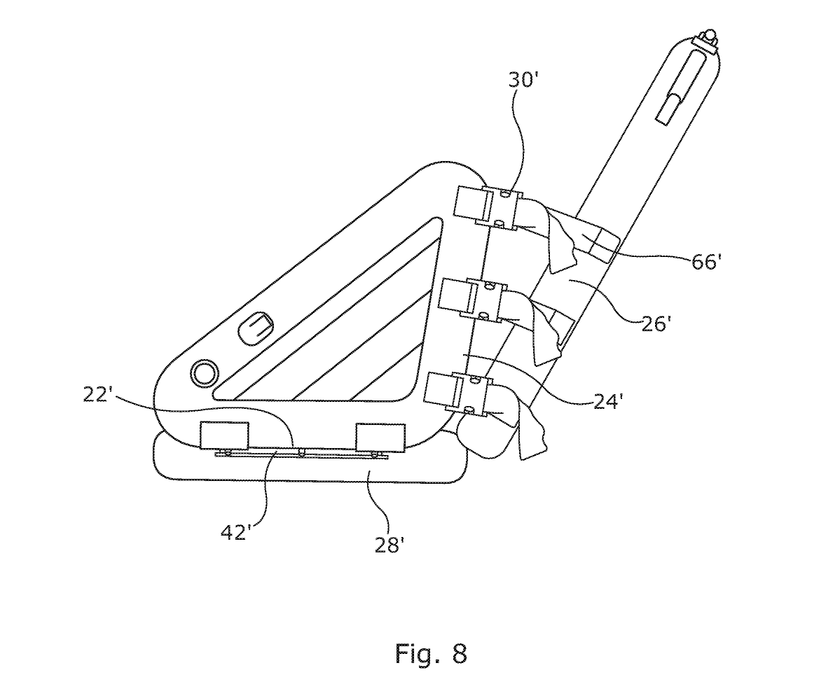

FIG. 8 is a view from the side of the cradle of FIG. 6 but with the lower leg support omitted and showing a back-support section in a semi-reclined position;

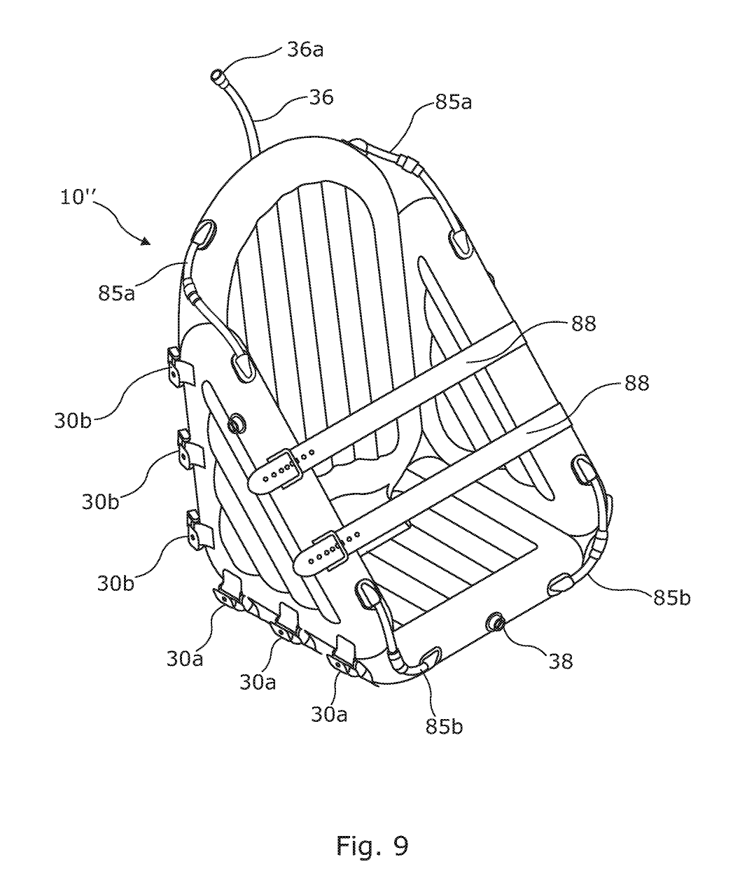

FIG. 9 is a perspective view of a third embodiment of an inflatable patient cradle which can be used as part of apparatus for handling a patient in accordance with the present invention, showing the cradle in an assembled and inflated configuration;

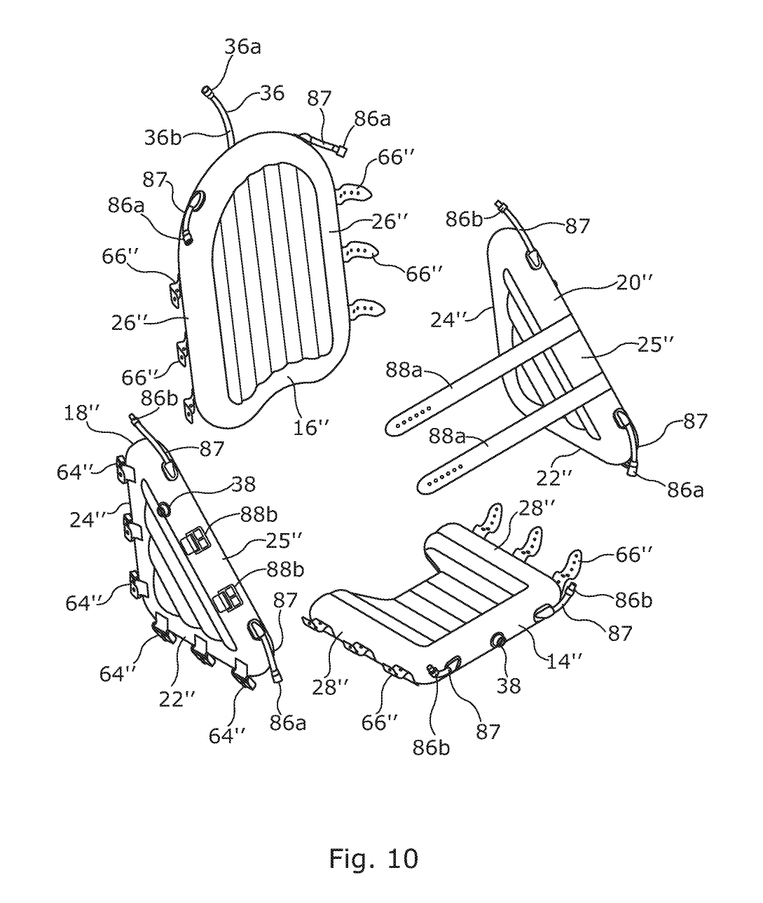

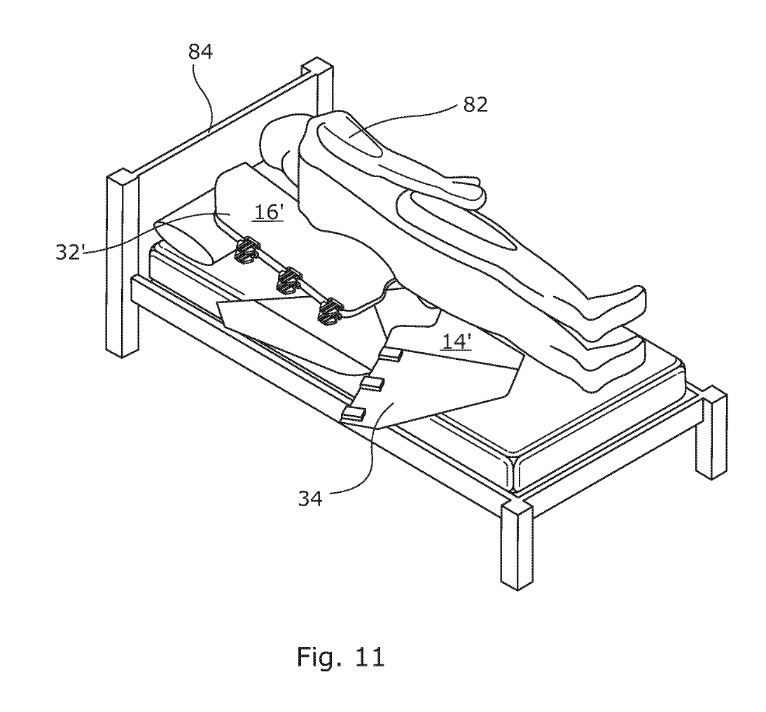

FIG. 10 is an exploded view of the cradle of FIG. 9;

FIGS. 11 to 17 are a series of perspective views illustrating fitting of the cradle of FIGS. 5 to 8 about a patient lying on a bed, subsequent inflation of the cradle and positioning the patient in an upright sitting position supported in the inflated cradle;

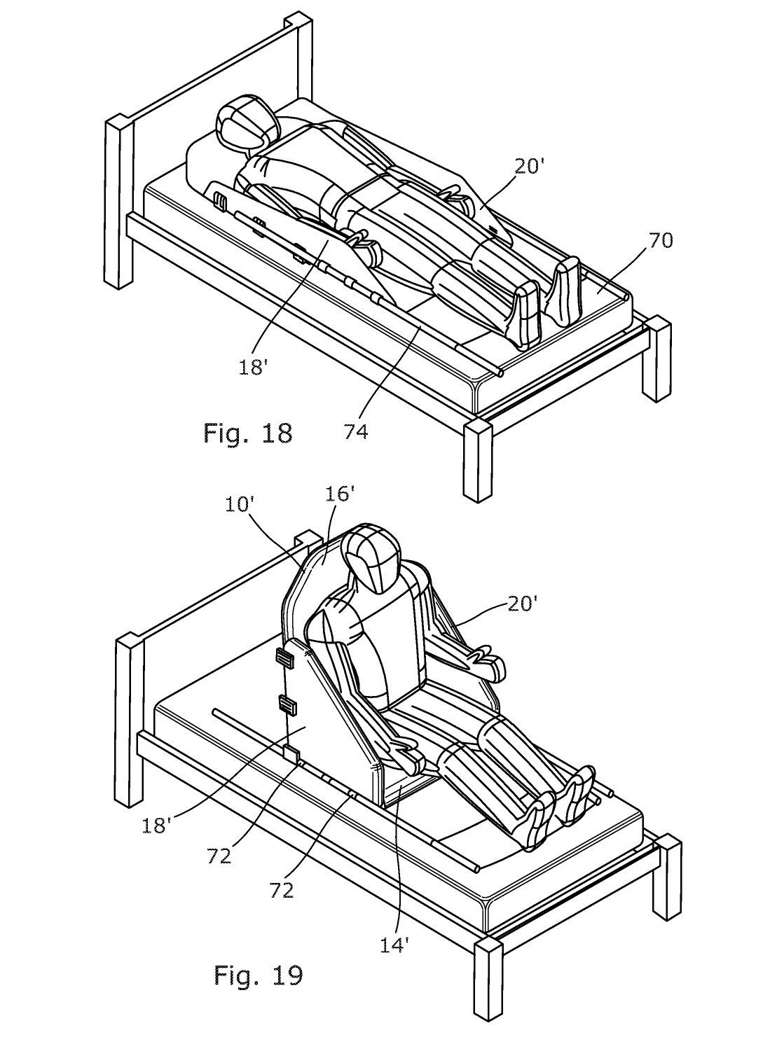

FIGS. 18 and 19 illustrate an alternative method of inflating the cradle of FIGS. 5 to 8 using a lower leg support to automatically place the patient in an upright sitting position as the cradle inflates;

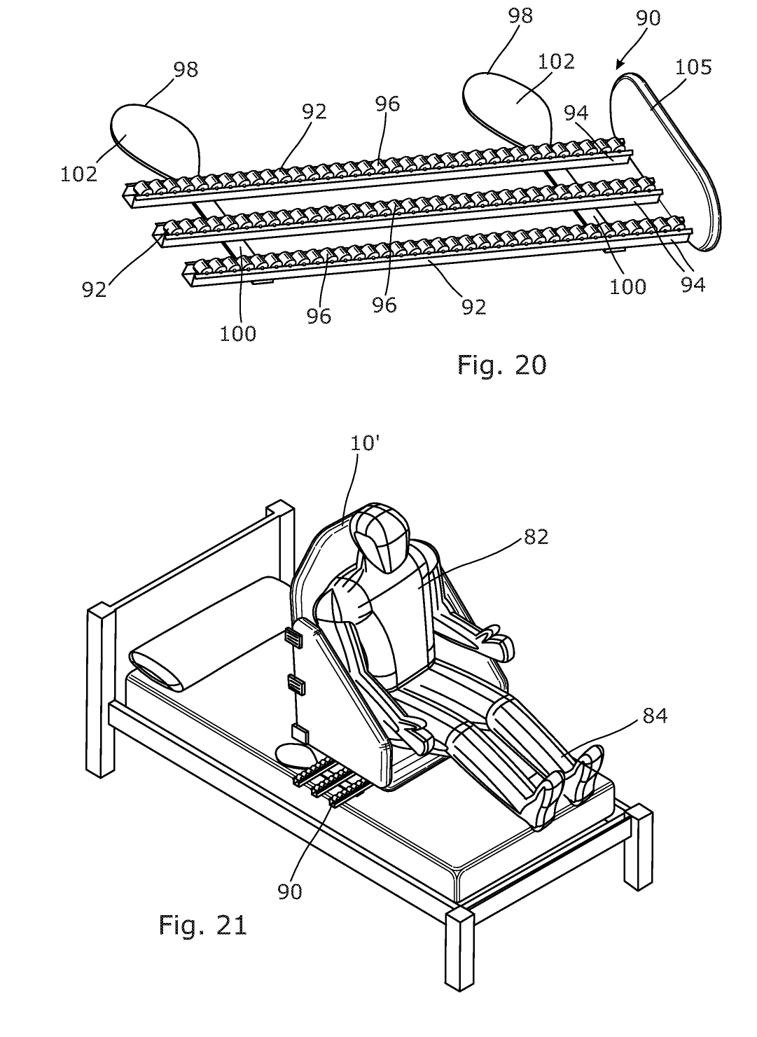

FIG. 20 is a perspective view of a roller transfer assembly forming part of apparatus for handling a patient in accordance with the present invention and which can be used together with an inflatable patient cradle;

FIG. 21 is a perspective view showing the roller transfer assembly of FIG. 20 in use on a bed to transfer a patient supported in the cradle of FIGS. 5 to 8;

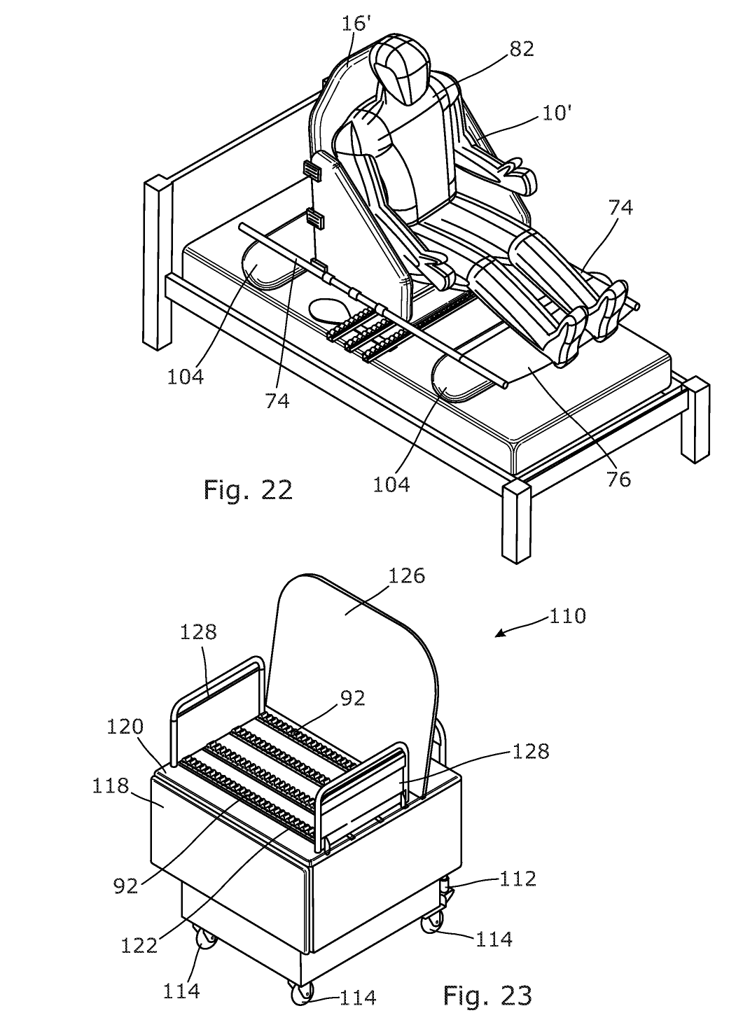

FIG. 22 is a perspective view illustrating a method of positioning an inflated cradle with a patient on-board on top of the roller transfer assembly of FIG. 20 on a bed;

FIG. 23 is a perspective view of a mobile transfer unit forming part of apparatus for handling a patient in accordance with the present invention;

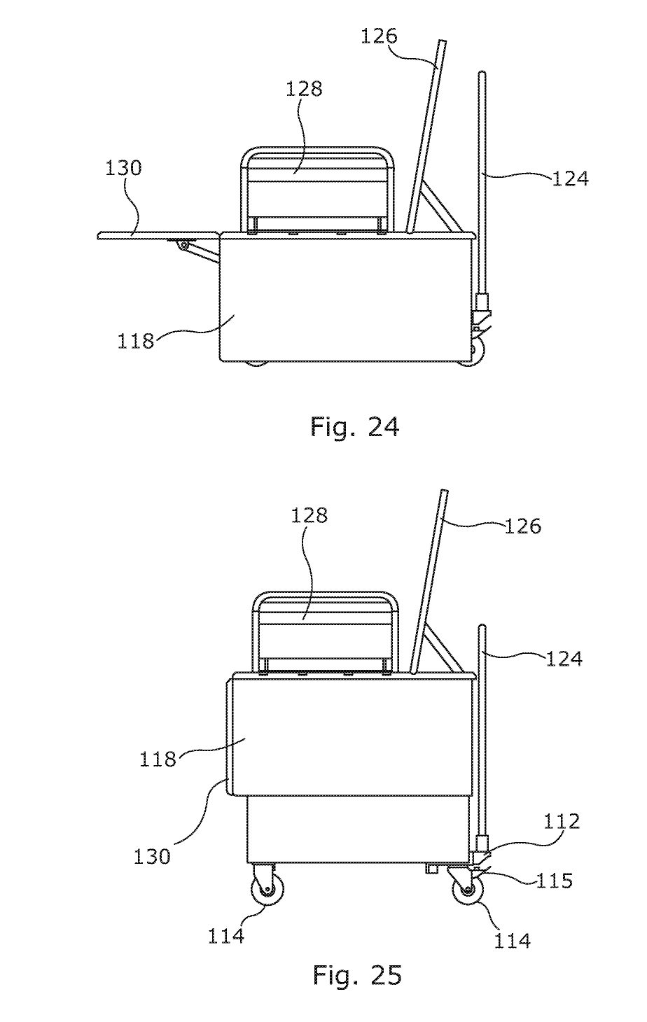

FIG. 24 is a side view of the mobile transfer unit of FIG. 23, showing the unit with a platform in a lowered position and a lower leg support panel in a raised position;

FIG. 25 is a view similar to that of FIG. 24 but showing the platform in a raised position and the lower leg support panel in a lowered position;

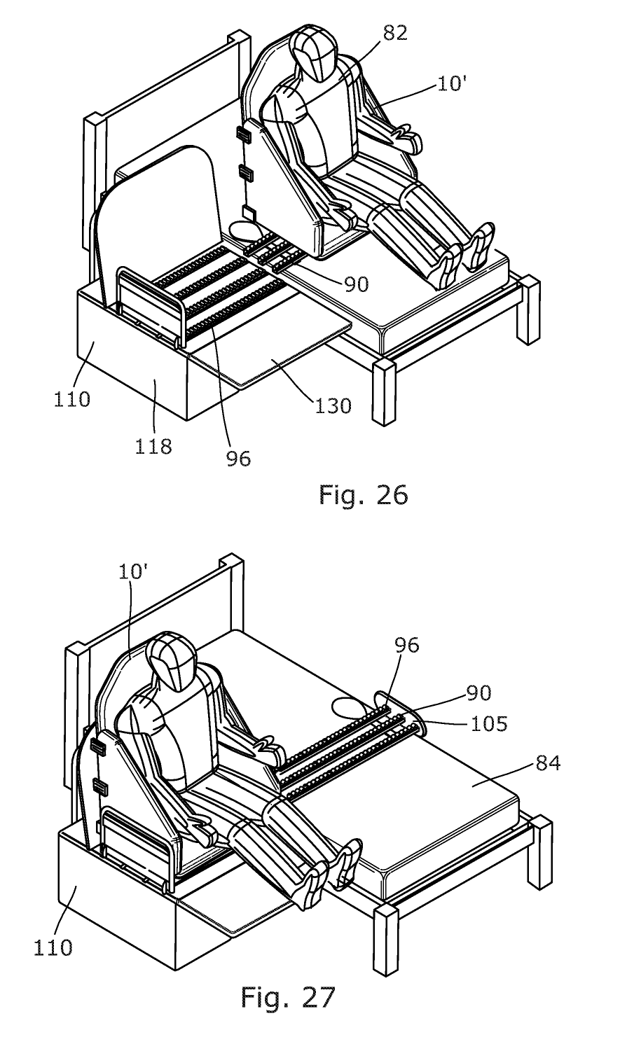

FIGS. 26 and 27 are a series of perspective views showing a patient supported in the cradle of FIGS. 5 to 8 being transferred from a bed onto the mobile transfer unit of FIG. 23 using the roller transfer assembly of FIG. 20;

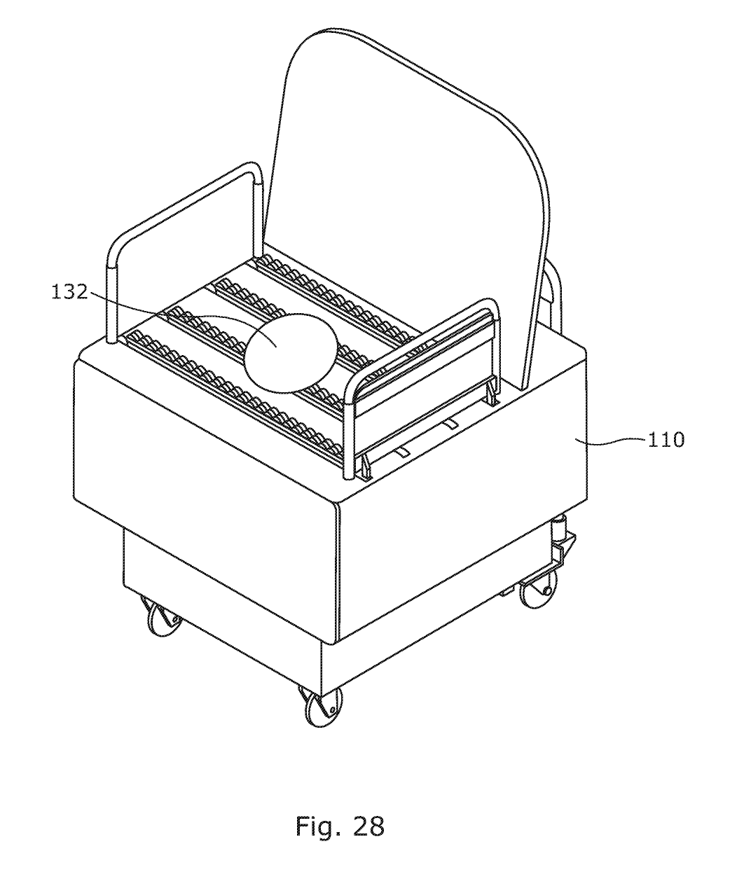

FIG. 28 is a perspective view of the mobile transfer unit of FIG. 23 modified for use in toileting a patient;

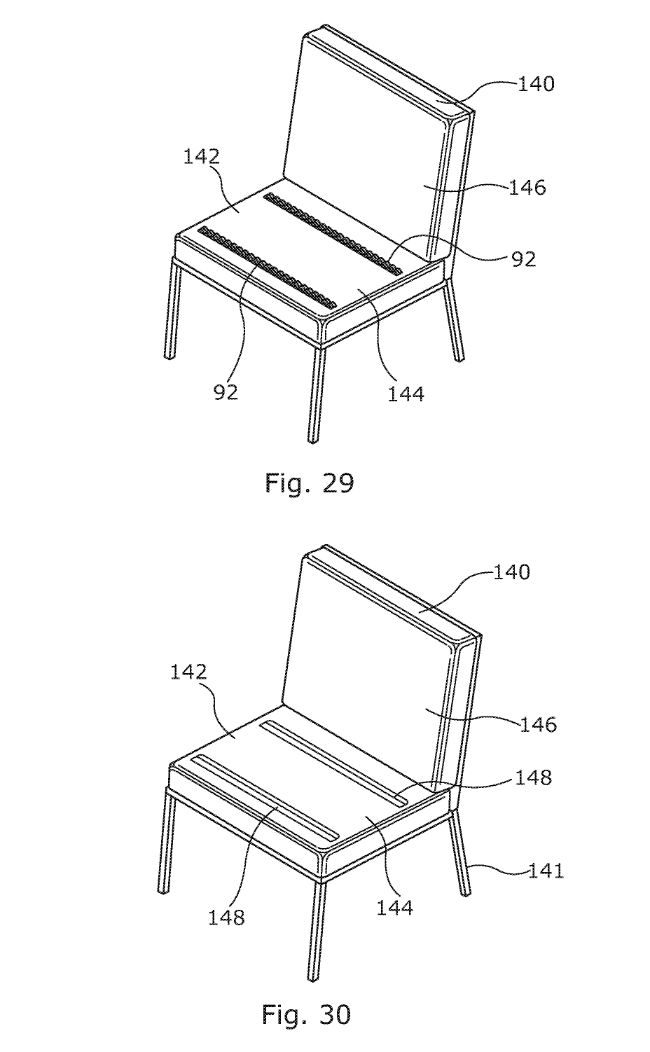

FIG. 29 is a perspective view of a chair incorporating an adjustable roller arrangement forming part of apparatus for handling a patient in accordance with the present invention, showing the rollers in a raised position;

FIG. 30 is a view similar to that of FIG. 29 but showing the chair with the rollers in a lowered position;

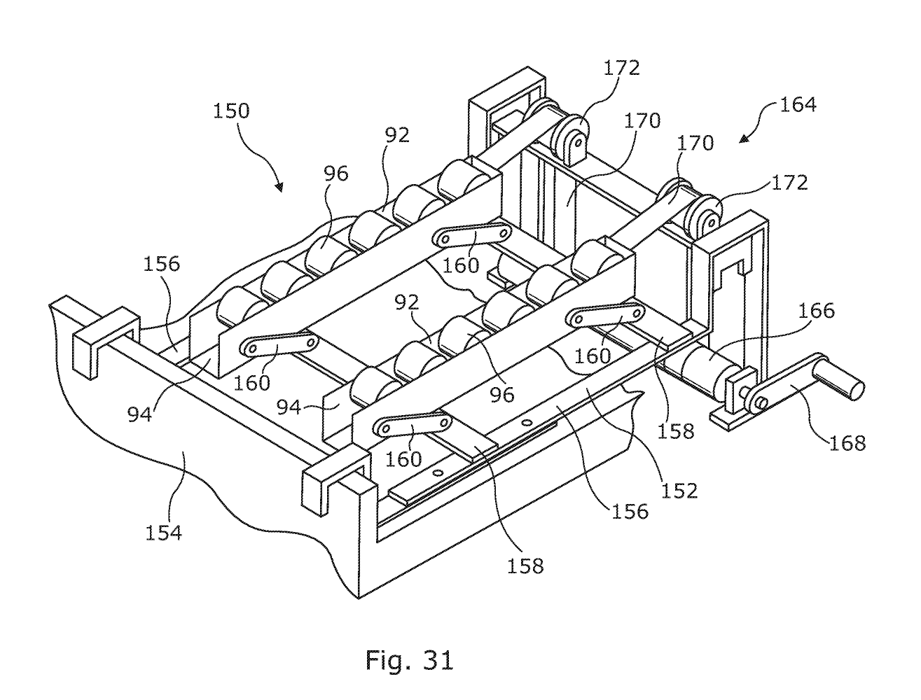

FIG. 31 is a perspective view of an adjustable roller baton assembly forming part of the chair of FIGS. 29 and 30;

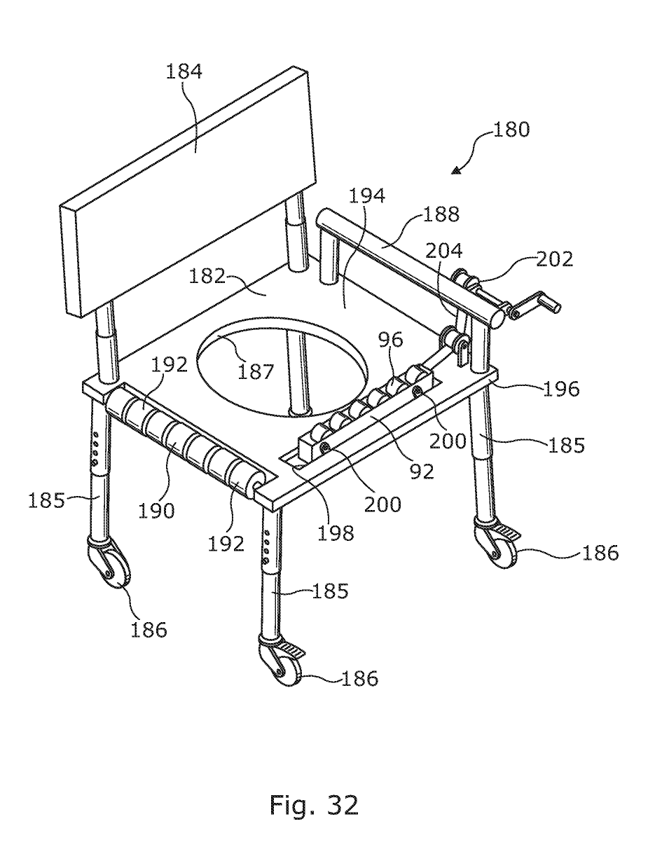

FIG. 32 is a perspective view of a toileting support forming part of apparatus for handling a patient in accordance with the present invention;

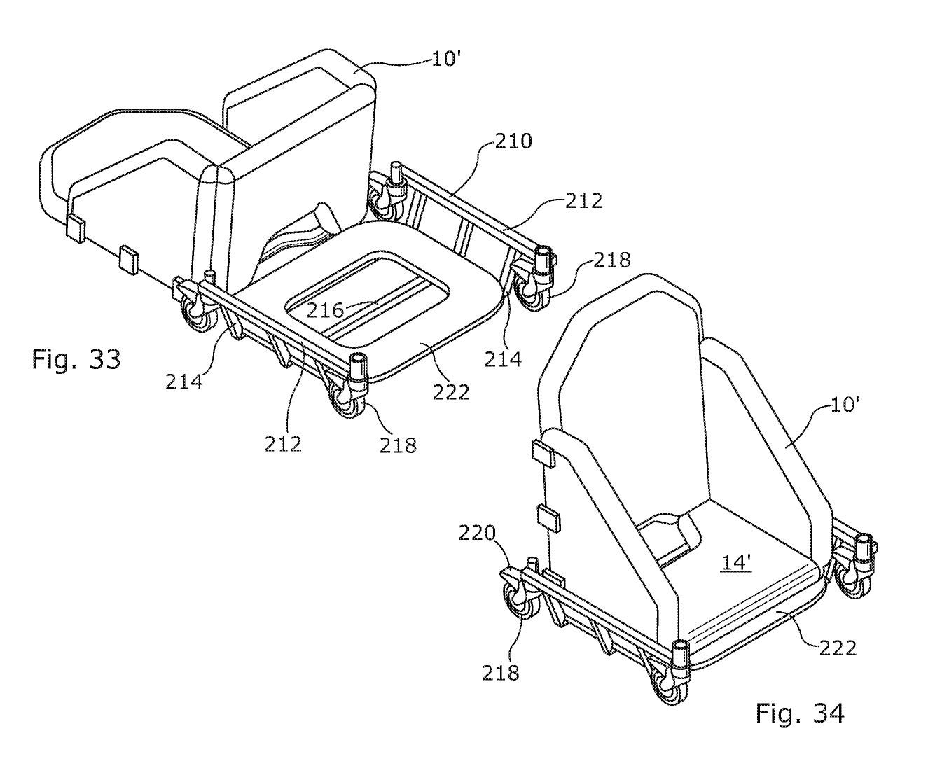

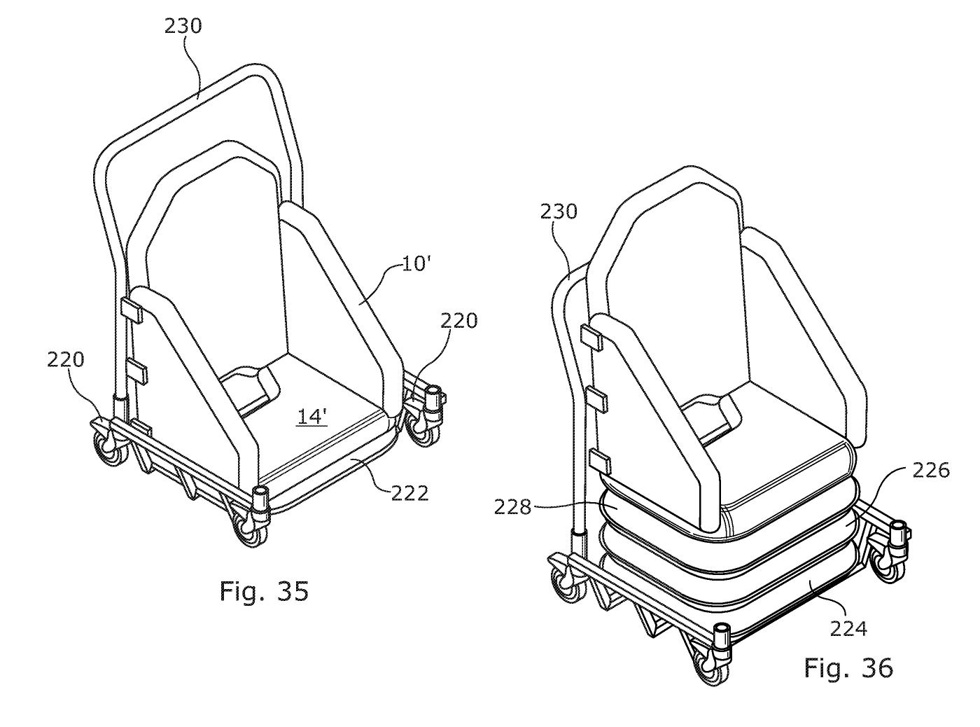

FIGS. 33 to 36 are a series of perspective views illustrating use of the cradle of FIGS. 5 to 8 in combination with a floor-lift unit also forming part of a system for handling a patient in accordance with the present invention;

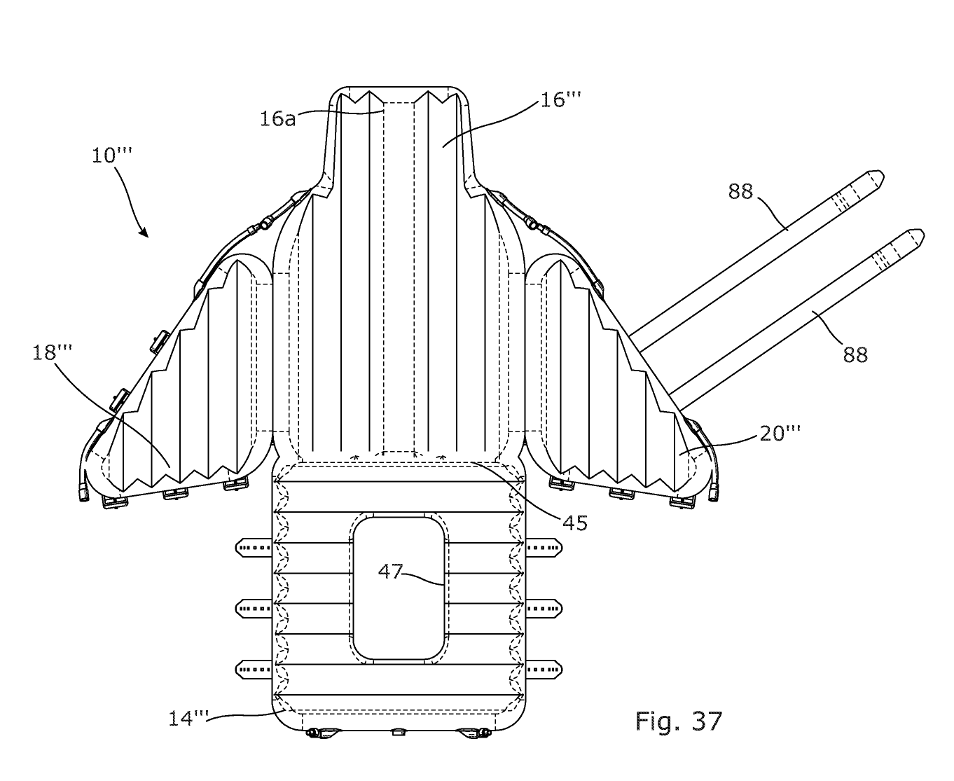

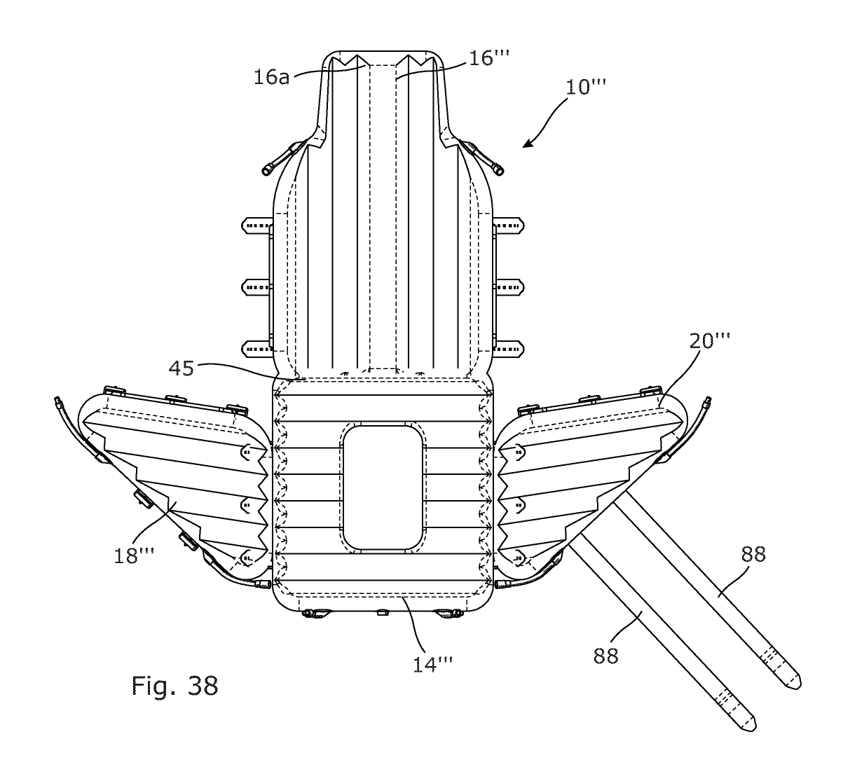

FIGS. 37 and 38 are views from above of two further embodiments of an inflatable patient cradle in accordance with the invention, showing the cradles in an un-assembled configuration for positioning about a patient;

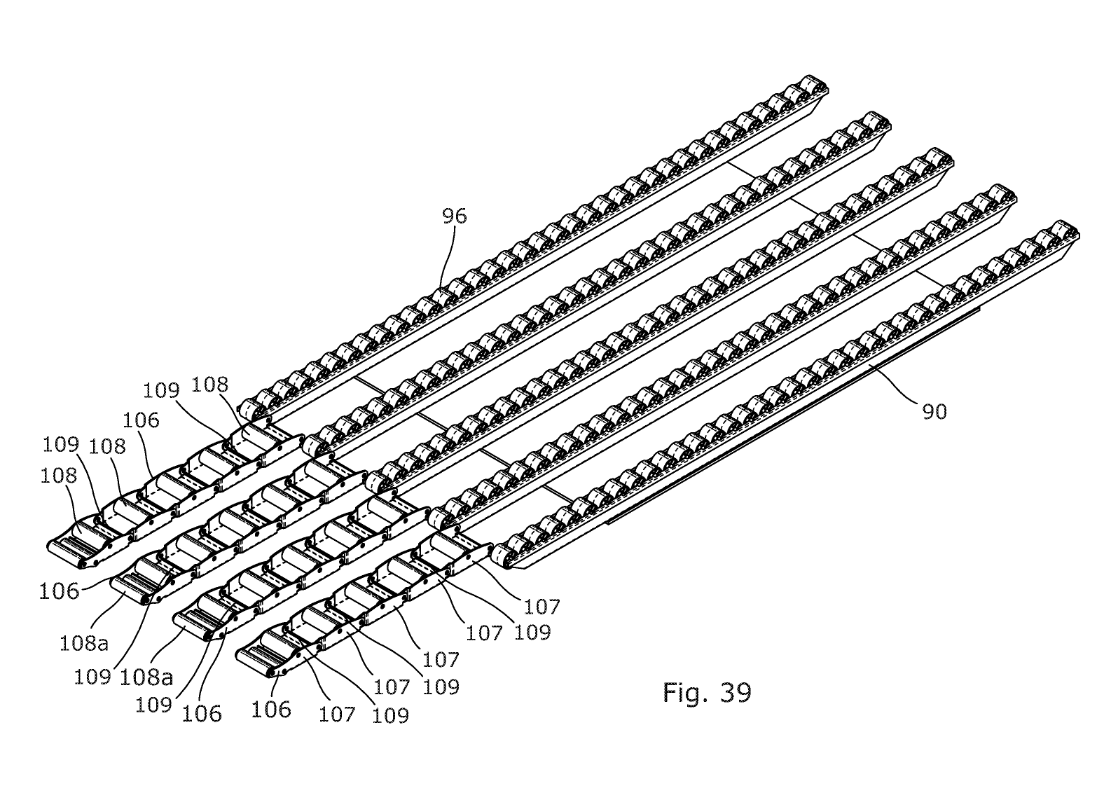

FIG. 39 is a perspective view of an alternative embodiment of a roller transfer assembly incorporating articulated elongate finger-like members;

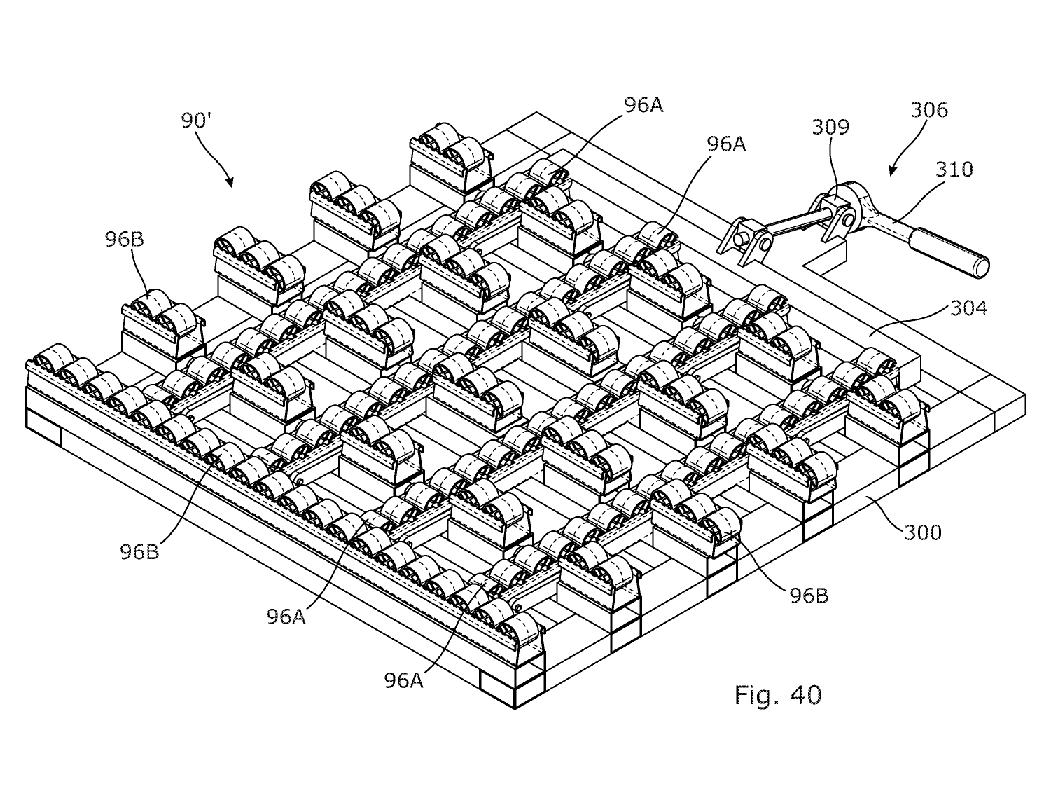

FIG. 40 is a perspective view of a further alternative embodiment of a roller transfer assembly adapted to selectively move a patient in either of two directions and showing the assembly in a first configuration;

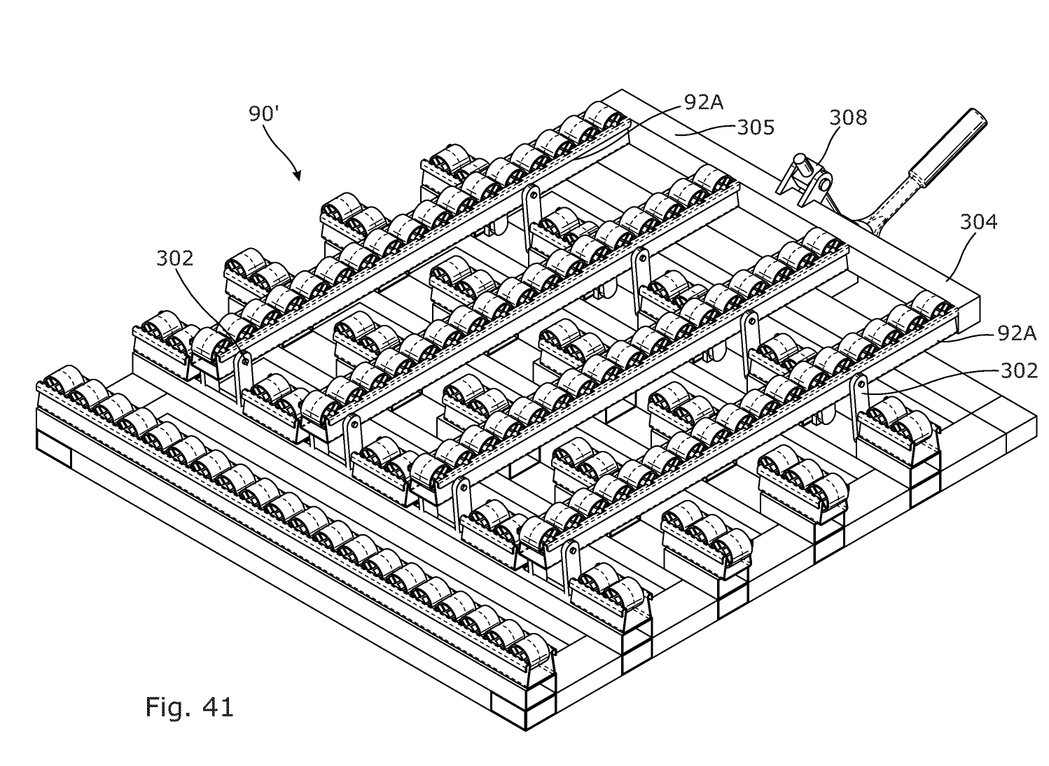

FIG. 41 is a view similar to that of FIG. 40 but showing the assembly in a second configuration;

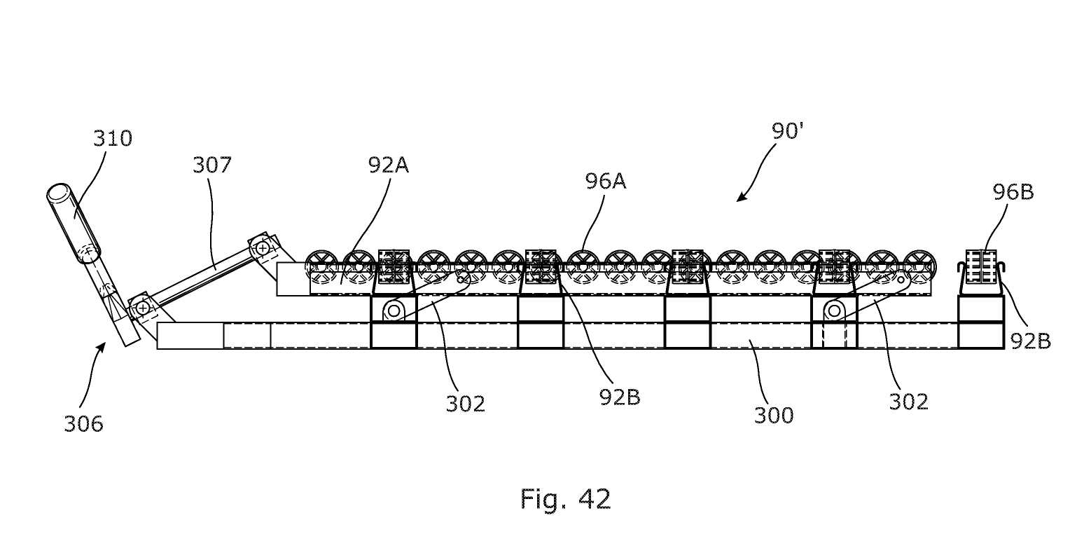

FIG. 42 is a cross-sectional view through the assembly of FIGS. 40 and 41;

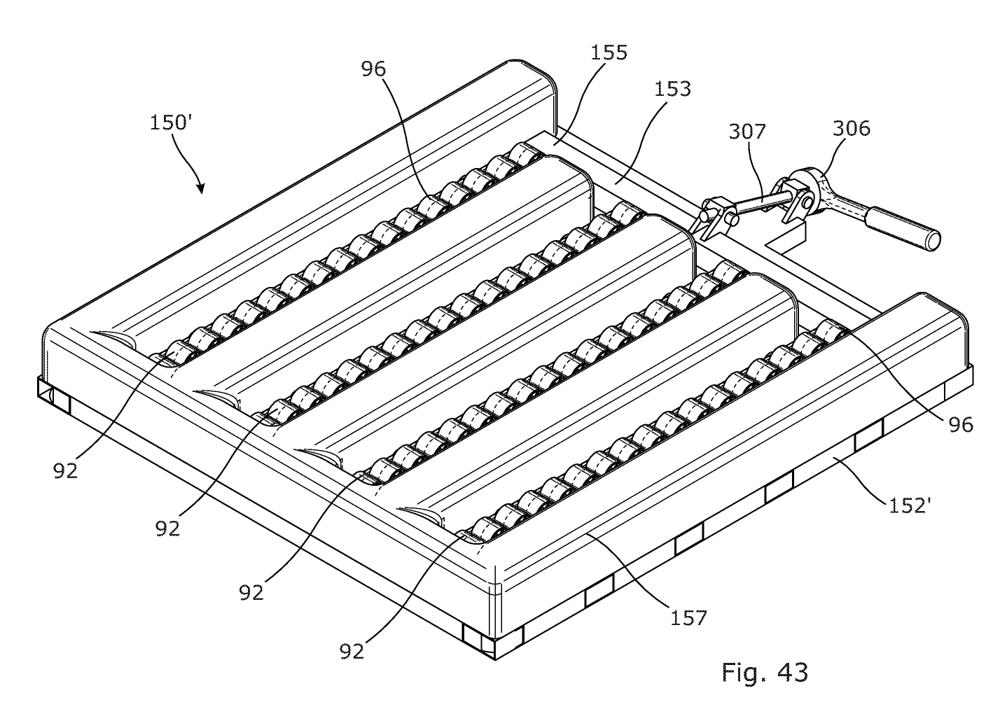

FIG. 43 is a perspective view of an alternative embodiment of an adjustable roller baton assembly, showing the assembly in a non-transfer configuration;

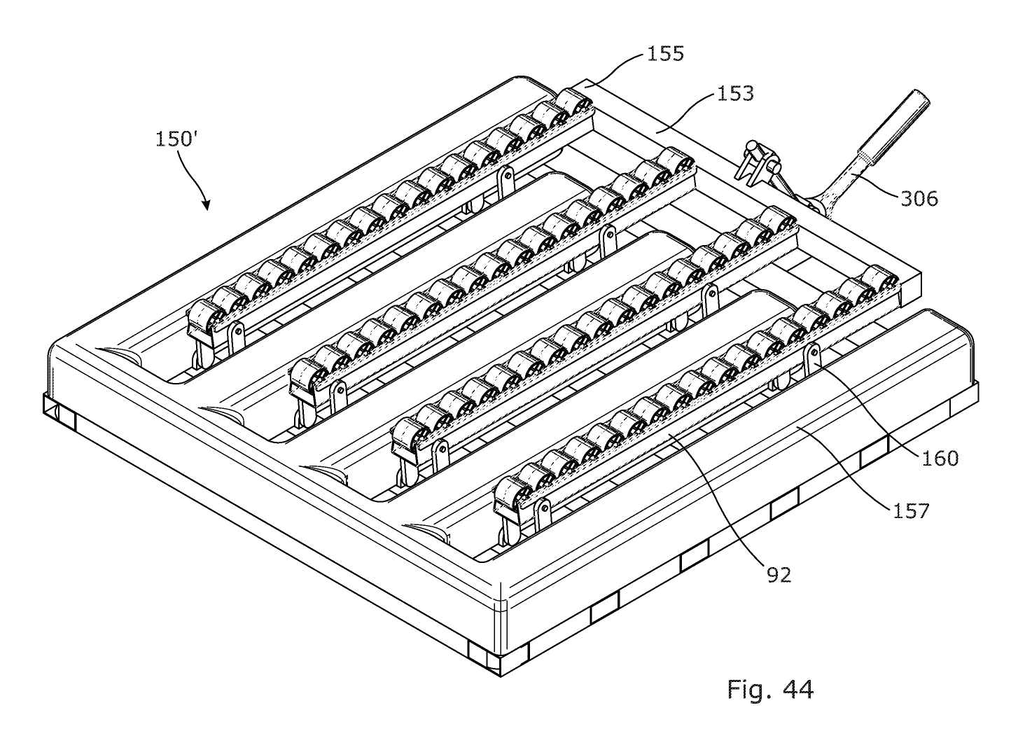

FIG. 44 is a view similar to that of FIG. 43 but showing the assembly in a transfer configuration;

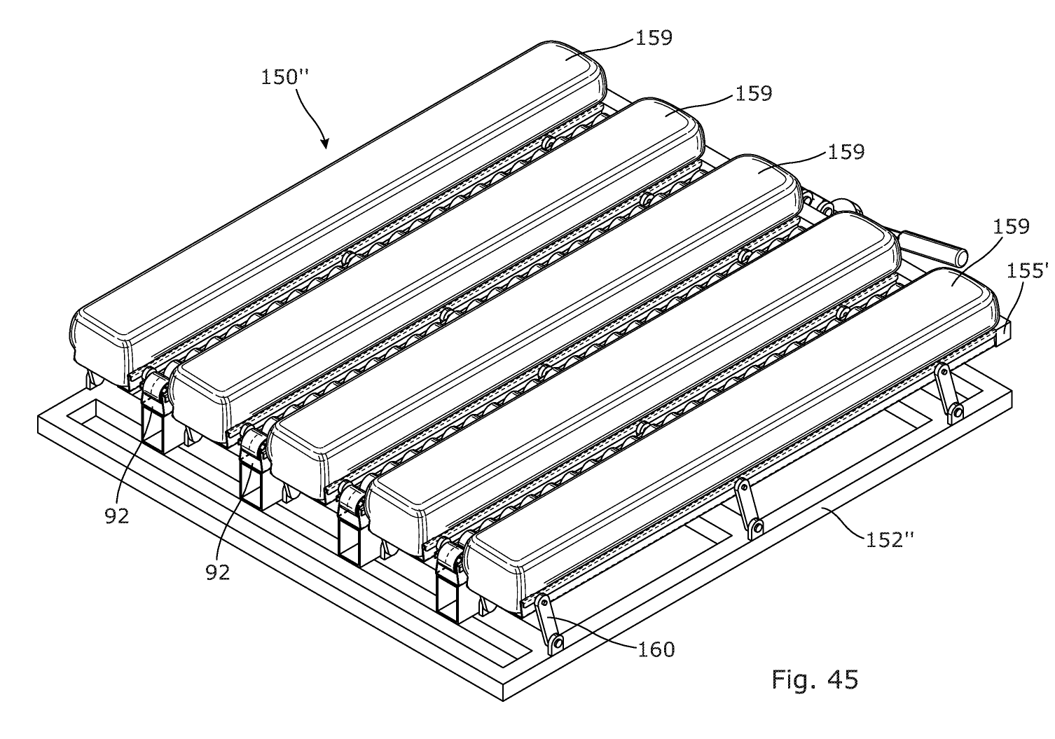

FIG. 45 is a perspective view of a still further embodiment of an adjustable roller baton assembly, showing the assembly in a non-transfer configuration; and

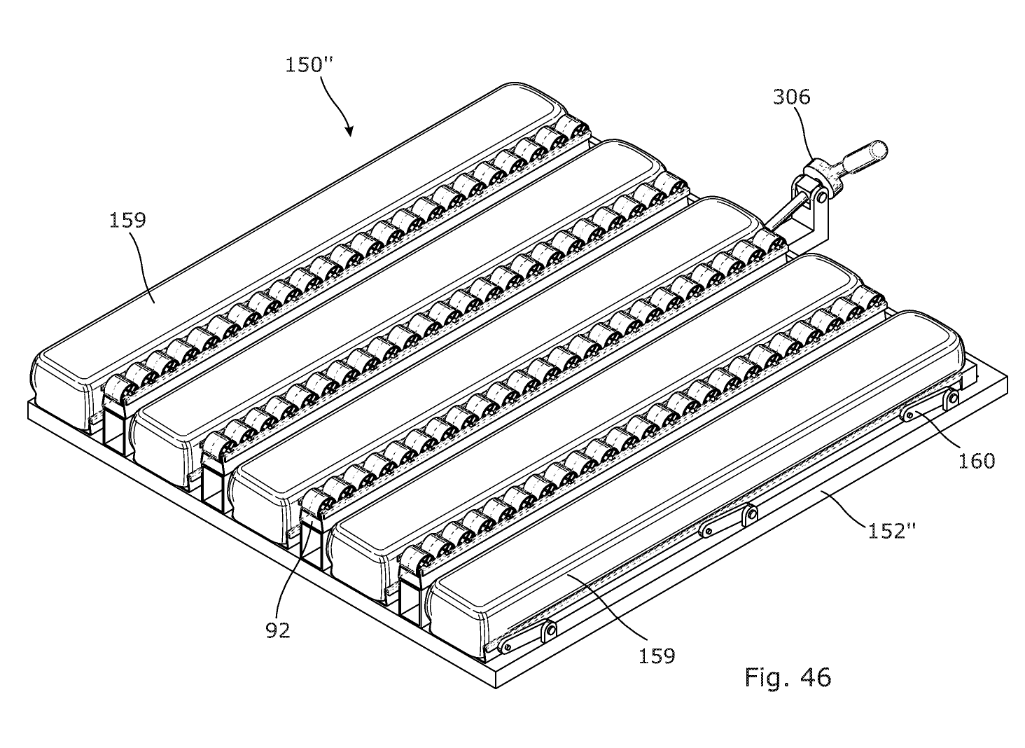

FIG. 46 is a view similar to that of FIG. 44 but showing the assembly in a transfer configuration;

FIGS. 1 to 4 illustrate a first embodiment of an inflatable patient transfer cradle 10 in accordance with an aspect of the invention. The inflatable patient transfer cradle can be used as part of apparatus in a method of handling a patient in accordance with a further aspect of the invention but can also be used independently of the method.

The cradle 10 is a pneumatically-inflatable device configured to be positioned in an un-inflated condition about a patient located on a surface and inflated to raise them off the surface. Once fully inflated, the cradle 10 forms a generally rigid, self-supporting seat structure in which the patient is stably and comfortably held in an upright sitting position for transfer in the cradle between different locations. The cradle 10 can be used, for example, to reposition a patient on a support surface but can also be used to transfer a patient from one supporting structure to another, such as between a bed and a chair.

The cradle 10 has a seat section 14, a back-support section 16 and opposed side panel sections 18, 20, each section being a soft-walled pneumatically- inflatable structure. In an upright condition when the cradle is inflated, as illustrated in FIGS. 1 to 4, the seat section is located generally horizontally on a supporting surface and the back-support section 16 extends upwardly from a rear edge of the seat section 14. The side panel sections 18, 20 are located on opposite sides and extend forwardly between the back-support section 16 and seat section 14 to which they are connected. The back-support section 16 may be slightly reclined rather than vertical for patient comfort.

In the assembled and inflated cradle, the side panel sections 18, 20 are each connected with seat section 14 and the back-support section 16 and are operative to hold the back-support section 16 in position extending generally upwardly from the seat section 14 in a self-supporting manner when a patient is sitting in the cradle with their back resting on the back-support section. Accordingly, the term “self-supporting seat structure” is used to refer to a structure which is capable of independently supporting a patient in an upright sitting position when the seat section 14 is located on a supporting surface without any external support to hold the back-support section 16 extending upwardly.

Relative directional terms such as “upper” and “lower”, “forward” and “rearward” and the like used in relation to the cradle or parts thereof refer to the cradle when in the upright inflated configuration as shown in FIG. 1 and should be understood accordingly. However, it will be appreciated that the cradle can be used in other orientations.

The term “upright sitting position” as used herein in relation to a patient supported in the inflated cradle refers to a position in which the patient's buttock region is supported on the seat section 14 when the seat section is generally horizontal, with their torso generally upright so that their upper legs extend at an angle to their upper body. Typically the patient's upper legs will extend at an angle to their torso in the range of 80 to 140 degrees, or more particularly 85 to 120 degrees. The term “sitting position” as used herein in relation to a patient supported in the inflated cradle refers to a position in which is similar to that of an upright sitting position as defined above but covers the situation where the seat section is not horizontal. The term “sitting position” thus covers the situation where the patient is supported in the inflated cradle but with the back-support section horizontal on a supporting surface and the seat section extending upwardly from the support surface.

The term “supine position” as used herein in relation to a patient refers to a position which the patient is lying on their back with their legs extending out in front of them on a surface on which they are lying. In this position, the patient's legs will be generally flat so that their upper thighs are in-line with their back. It will be appreciated that in practice the patient's thighs may be angled slightly, though not to the same extent as when the patient is in a sitting position.

When viewed in elevation from a side of the inflated cradle, each of the side panel sections 18, 20 is generally triangular in shape having a lower horizontal edge 22, a rear edge 24 which extends generally upwardly from the lower edge, and an angled forward edge 25 which extends from a forward end of the lower edge 22 to the upper end of the rear edge 24. The side panel sections 18, 20 are each connected along their rear edge 24 with a respective side edge region 26 of the back-support section 16 and along the lower edge 22 with the corresponding side edge region 28 of the seat section 14. Whilst a triangular shape has been found to be particularly advantageous for the side panel sections, it will be appreciated that the shape of the side panel sections can be varied.

The cradle 10 in this embodiment is formed in two separable parts 32, 34 connected together by means of releasable fasteners 30. The parts can be separated and positioned about a patient when un-inflated and subsequently connected together before being inflated. Each part is independently inflatable, though in practice both parts are typically inflated at the same time. In this embodiment, the side panel sections 18, 20 are constructed integrally with the back-support section 16 to form a first part 32 of the cradle and the seat section 14 is a separate component which forms a second part 34. In this arrangement, the lower edge regions 22 of the side panel sections are releasably attached to the sides 28 of the seat section 14 by means of the releasable fasteners 30. Each part 32, 34 of the cradle is a separately inflatable soft-walled body having a one-way inlet valve 36 through which air under pressure can be introduced to inflate the body and a release or dump valve 38 which can be selectively opened to allow air to escape to deflate the body.

Each of the two parts 32, 34 of the cradle are made from thin sheet material which is tough but very flexible and is impervious to air. The parts may be made of fabric material suitably treated to make it impervious to air, such as a polyurethane-coated nylon fabric for example. The material is formed into a bag-like structure or bladder for holding a volume of pressurised air (that is to say air at a pressure above the ambient air pressure). When un-inflated, each part 32, 34 is relatively thin and highly flexible and so is easily positionable beneath and/or about the patient when they are laid or sitting on a bed, chair or other similar supporting structure, for example in a manner similar to that used to position a glide sheet. Indeed, when un-inflated each part 32, 34 has a thickness substantially equal to twice the thickness of the sheet material from which it is made and has a flexible, fabric-like structure. Each part 32, 34 has opposed walls which define the major surfaces of the part when inflated. The opposed walls are interconnected by a series of internal webs and/or welds which limit their separation as the part is inflated in order to give a desired profile when inflated. The parts are profiled in this way so that each inflatable section 14, 16, 18, 20 defines a generally cylindrical outer frame portion 40 and a fluted region 41 within the outer frame to give the sections structural stability when inflated. In addition, the opposed walls in the first part 32 are welded together to define a hinge portion 42 between the back-support section 16 and each side panel section 18, 20. Fluid passages 43 are defined through the hinge portions 42 so that the back-support section 16 and the two side panel sections are fluidly interconnected to enable them to be inflated from a single inlet valve 36 and deflated through a single dump valve 38. However, each side panel section 18, 20 could alternatively be fluidly connected with the back-support section 16 by means of an external fluid connection having a coupling incorporating a non- return valve and in which parts of the coupling are connected to their respective section by a flexible hose.

The seat section 14 is in the form of an inflatable cushion for positioning under the thighs and buttock region of the patient. It has a generally rectangular profile in plan when viewed from above but with a recessed region or indent 44 centrally located along the rear edge 46 between a pair of rearwardly projecting shoulders 48. The opposed walls which define the major surfaces of the seat section are an inner or upper wall 50 on which the patient sits and an outer or lower wall 52 for positioning on a support surface when the cradle is positioned upright. The cylindrical outer frame portion 40 extends along either side and across the front of the seat section. When inflated, the fluted region 41 has a depth in the region of 3 cm to 10 cm so that a person seated on it can be stably supported with their buttocks and upper thighs raised off a support surface on which the lower wall 52 of seat section 14 is positioned.

In the first part 32 of the cradle, the opposed walls which define the major surfaces are an inner wall 53 which is directed towards the patient in use and an outer wall 54 which is directed away from the patient. The back-support section 16 and each of the side panel sections 18, 20 define an internal volume for containing a quantity of pressurised air so that they each form a substantially rigid, panel-like structure when inflated. The side panel sections 18, 20 are pivotally connected to the back-support section 16 along the hinge portions 42 where the inner and outer walls are welded together so that when the second part is inflated, the rigid side panel sections 18, 20 can be moved relative to the rigid back-support section and can be positioned to extend forwardly, substantially perpendicular to the back-support section 16.

The lower edge of the back-support section 16 has a central concave recess 56 between a pair of downwardly projecting shoulders 58 on either side. The central recess 56 aligns with the recessed region 44 along the rear edge of the seat section 14. These two recessed regions 44, 56 allow the seat section 14 and the back-support section 16 to be positioned about a person in an un-inflated condition whilst the person remains seated or lying on a surface without having to lift them fully off the surface, as will be described in detail later. This is particularly advantageous when positioning the cradle 10 about a person sitting upright on a chair where access to the patient from the side may be limited.

The cradle 10 is configured so that the seat section 14 is received in the space defined between the back-support section 16 and the two side panel sections 18, 20, when all the sections are inflated and the side panel sections 18, 20 are positioned to extend forwardly from the back-support section 16. A plurality of releasable fasteners 30 is provided to connect the lower edge region 22 of each of the side panel sections 18, 20 to a respective side edge region 28 of the seat section. In the present embodiment, three fasteners 30 are provided on each side and the fasteners are quick-release buckle type fasteners, each comprising a female buckle member 60 attached by means of a flexible strap 62 to an outer, lower edge region 22 of the respective side panel portion 18, 20 and a corresponding male buckle member 64 attached by a flexible strap or other fastening 66 to a respective side edge region 22 of the seat section 14. The buckle type fasteners 30 may be in the form of quick-release spring clips similar to those used on rucksacks in which the female buckle member 60 has a pair of resilient arms which are squeezed together for insertion into the male buckle member 64 and which after insertion spring out to engage with locking detents on the male buckle member 64 to prevent the female buckle member being pulled back out of the male member without first squeezing the resilient arms together. Apertures in the male buckle member 64 allow a user to squeeze the resilient arms inwardly to release the female buckle member. At least one of the straps 62, 66 may be adjustable in length to allow the angle of the back-support section 16 to be adjusted relative to the seat section 14 once the cradle has been inflated.

The releasable fasteners 30 transit forces in tension between the seat section 14 and the respective side panel section 18, 20 to hold the back-support section 16 upright though the side panel sections 18, 20 when the cradle is inflated. The fasteners 30 must be capable of transmitting sufficient force that the back-support section 16 is held upright when a patient is sitting in the inflated cradle with their upper torso resting on the back-support section 16 without the aid of any external support for the back-support section. This enables the cradle 10 to independently hold a patient in an upright sitting position when the cradle is positioned upright but where there is no external support against which the back-support section 16 of the cradle can be positioned, such as when the cradle is in the middle of a bed or when being moved between supporting surfaces, the forces that must be transmitted will depend on the size and weight of the patient but can be significant for use with bariatric patients.

The positions of the male and female buckle members 60, 64 could be reversed. Indeed, it should be appreciated that releasable fasteners 30 of any suitable type can be used to connect the seat section 14 and side panel sections 18, 20 subject to the requirements discussed above. These might include, for example, toggle fasteners, hook and loop fasteners, or strap and buckle type fasteners such as those described in relation to a third embodiment of the cradle described below.

It will be noted that all the structural parts of the cradle which support the patient are soft-walled inflatable structures. Only the fitments, such as the buckles and fluid inlets/outlets, are made of rigid materials. This makes it easier to place the cradle about a patient when un-inflated.

FIGS. 5 to 8 illustrate an alternative embodiment of a patient cradle 10′ also in accordance with the first aspect of the invention. The cradle 10′ is similar to the cradle 10 according to the first embodiment as described above to which the reader should refer and so only the significant differences will be described in detail.

The main difference between the cradle 10′ in accordance with the second embodiment and the first embodiment is that the side panel sections 18′, 20′ are integral with the seat section 14 to comprise the second part 34′ of the cradle, with the back-support section 16 on its own forming the first part 32′. The parts 32′, 34′ are manufactured in a similar manner to those of the first embodiment from a flexible membrane or fabric-like material formed into a bag-like or bladder structure for holding a volume of pressurised air with the opposed walls interconnected by a series of internal webs and/or welds in order to give a desired profile when inflated. In this embodiment, the opposed walls in the second part 34′ are welded together to define a hinge portion 42′ between the side edges 28′ of the seat section 14′ and the lower edge region 22′ of each side panel section 18′, 20′.

The side panel sections 18′, 20′ are releasably connectable along their rear edge regions 24′ to respective side edge regions 26′ of the back-support section 16′ by means of a plurality of releasable fasteners 30′, similar to those used in the first embodiment to attach the side panel sections to the seat section as described above. FIG. 8 illustrates how the straps 66′ connecting buckle members to the sides of the back-support section 16′ can be lengthened to allow the back-support section 16′ to be reclined. Usually, the straps 66′ are adjusted to hold the back-support section 16′ in close contact with the rear edge regions 24′ of the side panel sections when the cradle is being fitted and during inflation. Adjustment to allow the back-support section 16′ to be reclined will usually only be carried out after the cradle is fully inflated where this is desirable for the comfort of the patient and is safe to do so. Similar adjustment of the fasteners 30 is possible with the first embodiment to allow the back-support section 16 to be reclined.

It will be noted that in this second embodiment, the lower end of the back-support section 16′ has a more pronounced central recessed region 56′ and downwardly projecting shoulders 58′, whilst the recess 44′ along the rear edge of the seat section 14′ is less pronounced. The shapes of the recess 44, 44′, 56, 56′ in the seat and back-support sections in any of the embodiments disclosed herein can be varied to suit particular applications. Accordingly, the cradle 10′ in accordance with the second embodiment could have seat and back-support sections having recesses shaped like those of the first embodiment and vice versa. However, it should also be noted that the seat section and/or back-support section could be formed without a recess 44, 44′, 56, 56′.

As illustrated in FIGS. 5 to 7, a leg support attachment 70 can be used in conjunction with the cradle 10′. A number of flexible hoops 72 are spaced along the outside of the lower edge region 22′ of each of the side panel sections 18′ 20′. The hoops 72 are aligned and dimensioned to receive elongate side bars 74 which engage in the hoops along respective sides and project forwardly of the seat section. The side bars 74 are rigid and weight-bearing and may be round, tubular members made from any suitable but preferably light weight load-bearing material. Each side bar 74 could be made up of a number of sections which are releasably connected together. A sling or support 76 made of a flexible material has hoops 78 on either side which can be slid over the forward ends of the side bars 74. The sling 76 is arranged to locate under the lower legs/calf region of a person seated in the cradle so as to hold and support their legs projecting straight out in front. This may be necessary for patients who have had hip or knee joint replacements or where it is otherwise desirable that the patient's legs be supported. The leg support 70 also enables the cradle 10′ to be used to automatically sit a patient upright from a supine position during inflation, as will be described later. The number of hoops 72 along each side of the cradle can be varied and some drawings show two hoops 72 whilst others show three. It should also be noted that the hoops 72 could be provided on the sides of the seat section 14′. The side bars 74 may also project rearwardly beyond the cradle to provide additional stability. The cradle 10 in accordance with the first embodiment can be adapted to receive a leg support attachment 70 and it will be appreciated that other arrangements for attaching a lower leg support to the cradle could be adopted in any of the embodiments.

FIGS. 5 to 8 also show how grab handles 80 can be provided on the cradle at various locations. The handles can be grasped by a care giver to assist in manoeuvring the inflated cradle 10′ with a patient on-board. Similar grab handles 80 can be provided on the cradle according to any of the embodiments described herein.

A range of cradles 10, 10′ in different sizes can be provided. It is expected that for most applications the cradle 10, 10′ will be dimensioned to support an adult, including bariatric adults, although versions for children or smaller adults may also be useful. For use with very large bariatric patients, the two parts of the cradle may have to be so large that they become difficult to handle and manipulate around the patient. To overcome this problem, one or both of the seat section 14, 14′ and the back-support section 16, 16′ could be split into two or more parts that can be fastened together, say using releasable fastenings similar to the fasteners 30. For example, the seat section 14, 14′ and the back-support section 16, 16′ could each be made in two separately inflatable halves that are fastened together once placed in position about the patient. Each part would be provided with its own inlet valve 36 and outlet dump valve 38. Alternatively, the two parts may be fluidly interconnected by means of an external releasable fluid coupling so that they can be inflated through a single fluid inlet.

In addition, or alternatively, the cradle may have separable side panel sections 18, 20, 18′, 20′ which are releasably connectable to both the back-support section 16, 16′ and the seat section 14, 14′. A third embodiment of an inflatable cradle 10″ in accordance with the invention and which has separable back-support 16″, seat 14″, and side panel sections 18″, 20″ is shown in FIGS. 9 and 10. Each inflatable section 16″, 14″, 18″, 20″ is constructed in a similar manner to the corresponding section in the previous embodiments and is made from similar materials. The reader should refer to the description of the previous embodiments for details. However, rather than the side panel sections 18″, 20″ being integrally formed with either the back-support section or the seat section, each side panel section 18″, 20″ is a separate inflatable body which is releasably attachable to both the seat section 14″ and the back-support section 16″.

Each side panel section 18″, 20″ is releasably connectable to the seat section 14″ by means of a first set of releasable fasteners 30a and with the back-support section 16″ by means of a second set of releasable fasteners 30b. The releasable fasteners 30a in the first set are each operative between the lower side edge region 22″ of the side panel section and the respective side edge region 28″ of the seat section 14″, whilst the releasable fasteners 30b in the second set are each operative between the rear edge region 24″ of the side panel section and the respective side edge region 26″ of the back-support section 16″. There are three fasteners 30a, 30b in each of the first and second sets, though the number of releasable fasteners can be varied. Each fastener 30a, 30b comprises a conventional type buckle 64″ attached to an outer surface of the side panel section 18″, 20″ and a corresponding flexible strap 66″ attached to the respective side edge 26″, 28″ of the back-support section 16″ or seat section 14″. The strap 66″ is releasably and adjustably secured to the buckle 64″ in the usual manner. To this end, the strap 66″ has a number of holes spaced along its length into which a pin on the buckle can be inserted. Other types of buckle such as a cam buckle or a ladder buckle could be used. Indeed, other forms of releasable fastener could be used to attach the side panel sections such as the fasteners 30 described in relation to the previous embodiments.

All the sections 14″, 16″, 18″, 20″ are inflated via a single one-way inlet valve 36 located on the rear surface at the top of the back-support section 16″. The inlet valve 36 has a female coupling 36a fluidly connected with the interior of the back-support section by a flexible hose 36b. The female coupling 36a includes a non-return valve. The interior of each side panel section 18″, 20″ is fluidly connected to the interior of the back-support section 16″ by means of a first external fluid connector 85a and with the interior of the seat section 14″ by means of a second external fluid connector 85b. Each fluid connector includes a female coupling 86a having a non-return valve and a male coupling 86b which is releasably insertable into the female coupling 86a to create a flow path. The non-return valve prevents pressurised air flowing out of the respective body section through the female coupling 86a when the male coupling 86b is disconnected. Each female and male coupling 86a, 86b is fluidly connected to the interior of its respective section of the cradle by a flexible hose 87. It is preferred that in the second fluid connectors 85b, the female coupling is connected with the interior of the respective side panel section 16″, 18″. This enables the seat section 14″ to be separated from the side panel sections 16″, 28″ when the cradle is inflated without the side-panel sections 16″, 18″ and the back-support section 16″ deflating.

When the first and second fluid connectors 85a, 85b are coupled, a fluid path is created between all the sections of the cradle 10″ so that the cradle can be inflated from a single source of pressurised air connected to the inlet valve 36. The source of pressurised air will typically have an outlet hose with a male coupling which is insertable in the female coupling 36a of the inlet valve to allow air under pressure to be introduced into the cradle from the source. Once inflated, the source of pressurised air can be disconnected by withdrawing the male coupling from the female coupling 36a, the non-return valve in the female coupling 36a retaining the pressurised air in the cradle. As noted above, the second fluid connectors 85b can be disconnected to enable the seat section 14″ to be deflated and/or removed from the remainder of the cradle whilst the side panel sections and the back-support section remain inflated. The seat section 14″ can be subsequently re-inflated by reconnecting the second fluid connectors 85b and topping up the fluid pressure through the inlet valve 86.

Whilst there is only one inlet valve 36 in the present embodiment, additional inlet valves could be provided. For example a further inlet valve could be provided on the seat section 14″. Each of the seat, back-support, and side panel sections 14″, 16″, 18″, 20″ is provided with a dump valve 38 to enable the various sections to be deflated quickly and easily.

External fluid connectors similar to the connectors 85a, 85b described above can be adopted in the inflatable cradle 10, 10′ according to either of the first two embodiments to fluidly interconnect some or all of the inflatable sections in those cradles and to allow inflation of the cradle from a single inlet. Also, a similar inlet valve arrangement to that used in the cradle 10″ according to the third embodiment can be adopted for the inlet valves 36 in either of the cradles 10, 10′ according to the first and second embodiment.

The cradle 10″ according to the third embodiment has a pair of safety restraints 88 which are releasably connectable between the forward edge regions 25″ of the side panel sections 16″, 18″ to securely hold a patient in the cradle when it is inflated. Each restraint 88 comprises a flexible strap 88a attached to a forward edge region 25″ of one of the side panel sections 20″ and a corresponding buckle 88b attached to the forward edge region 25″ of the other of the side panel sections 18″. The straps 88a are releasably and adjustably secured across the front of the inflated cradle using the buckles 88b. The number and position of the restraints 88 can be varied. Similar restraints can be provided on the cradle 10, 10′ according to either of the previous embodiments. Other arrangements for releasably securing a strap or similar restraint across the front of the cradle can be adopted. Other arrangements for holding a patient securely in the cradle can also be adopted, such as a harness or the like.

The cradle 10″ according to the third embodiment can be provided with a rigid leg support 70 similar to that described above in relation to the second embodiment 10′. To this end, hoops 72 of flexible material can be provided spaced apart along the side edge regions of the side panel sections 18″, 20″ or the seat section 14″. However, other means of releasably securing a leg support 70 can also be adopted.

Use of the patient cradle 10, 10′, 10″ in the embodiments introduced so far will now be described. At least the surfaces on the cradle 10, 10′, 10″ which the patient will come into contact with may be made from or covered with a material of relatively low frictional resistance. Such materials are sometimes referred to as high slip materials. The material could be provided in the form of separate sheets that are placed between the cradle 10, 10′, 10″ and the patient each time it is used or in the form of covers that are semi-permanently fitted over the various parts of the cradle. The covers may be removable to allow for replacement, repair and/or cleaning. Alternatively, a low friction material may be permanently applied to the relevant surfaces of the cradle. The low friction/high slip material may be polyester and/or nylon or any other suitable material such as are used in the manufacture of glide sheets for patient transfer. The low friction/high slip material may comprise a base material coated with silicon or some other low friction substance. It should be assumed in the following description of the use of the cradle that a high slip material is always in position between the cradle and the patient. If this material is not present on the cradle parts themselves, then sheets of high slip material are placed between the parts of the cradle and the patient during the following procedures.

FIGS. 11 to 17 illustrate somewhat schematically a sequence for positioning a patient in the cradle 10′ according to the second embodiment. Similar procedures modified accordingly can be adopted for the cradle 10, 10″ in accordance with the first and third embodiments. In this sequence, the patient 82 is initially in a supine position on a bed 84 and may have insufficient upper body strength to support themselves in a sitting position on the bed.

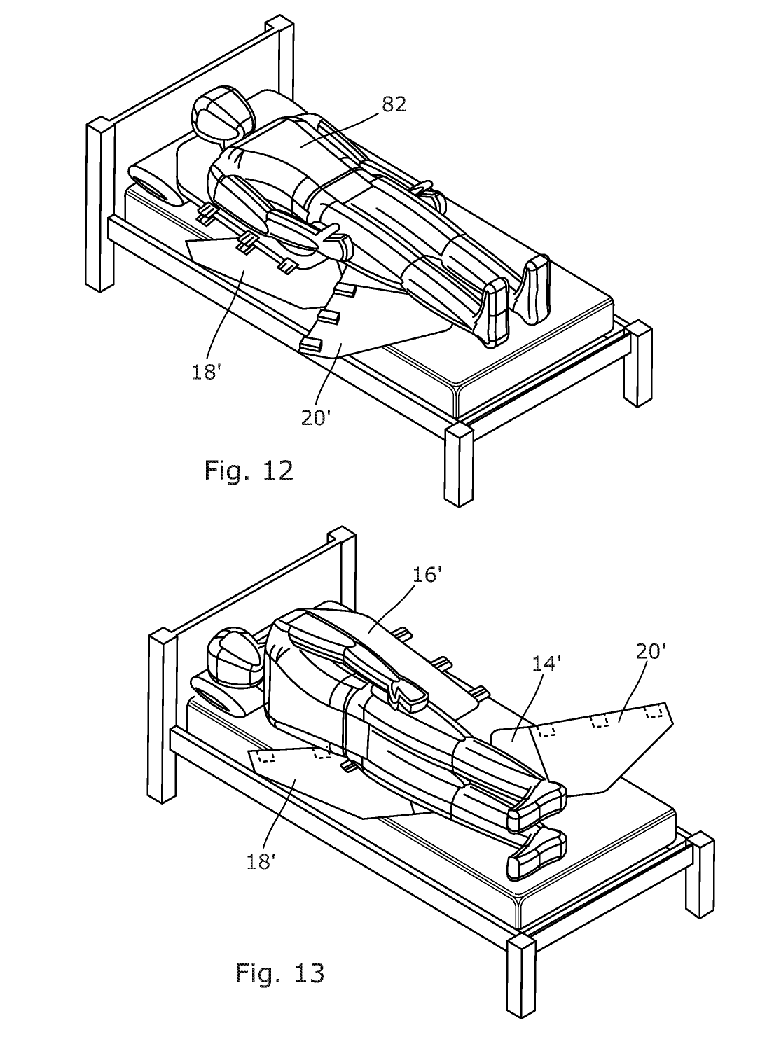

Starting with the patient 82 in a supine position on the bed 84, the two parts 32′, 34′ of the cradle 10′ are separate and in a fully deflated condition. The patient 82 is first rolled over to one side as shown in FIG. 11. The back-support portion 16′ is folded in half longitudinally and placed on the bed behind the patient's back and tucked in as close to the patient as possible. The second part 32′, including the seat section 14′ and the side panel sections 18′, 20′, is similarly folded in half and placed on the bed behind the patient's buttocks and thighs as close to them as possible. The patient 82 is gently rolled back into the supine position on top of the folded parts of the cradle and then onto their other side as shown in FIGS. 12 and 13. The folded half of the back-support section 16′ is teased through under the patient so that the back-support section is lying flat on the bed. Similarly, the folded half of the seat section 14′ and the attached side panel 20′ on that side are teased through under the patient until they lie flat on the bed. The patient is now rolled back into the supine position so that they are lying with their back on the un-inflated back-support section 16′ and at least their upper thighs on the seat section 14′. During the above procedures, the back-support section 16′ is pulled down the bed so that its lower end is as close to the patient's buttocks as possible and the seat section 14′ is pulled up the bed so that its rear edge is as close to the patient's buttocks and to the lower end of the back-support section as possible. The material at the lower end of the back-support section 16′ and the rear end of the seat section 14′ may be bunched up around the patient's buttocks/hips so that when these sections inflate, the material works its way further under the patient to assist in lifting them off the surface of the bed. This is made possible due to the flexible nature of the cradle when un-inflated and is assisted by the recessed regions 44′, 56′ at the rear edge of the seat section 14′ and the lower edge of the back-support section 16′, which allow the patient's buttocks to remain in contact with the bed. However, it is not essential that the rear edge of the seat section 14′ and the lower edge of the back-support section 16′ have recesses and the rear edge of the seat section and the lower edge of the back-support section be overlapped under the patient so that no part of them is in contact with the bed.

An advantage of the second embodiment of the cradle 10′ in which the side panel sections 18′, 20′ are attached to the seat section 14′ is that the side panel sections can be used to pull the seat section 14′ into position under the patient. However, it will be appreciated that the precise method for placing the seat section and the back-support section under the patient can be varied from those described above, which is only one of many possible methods.

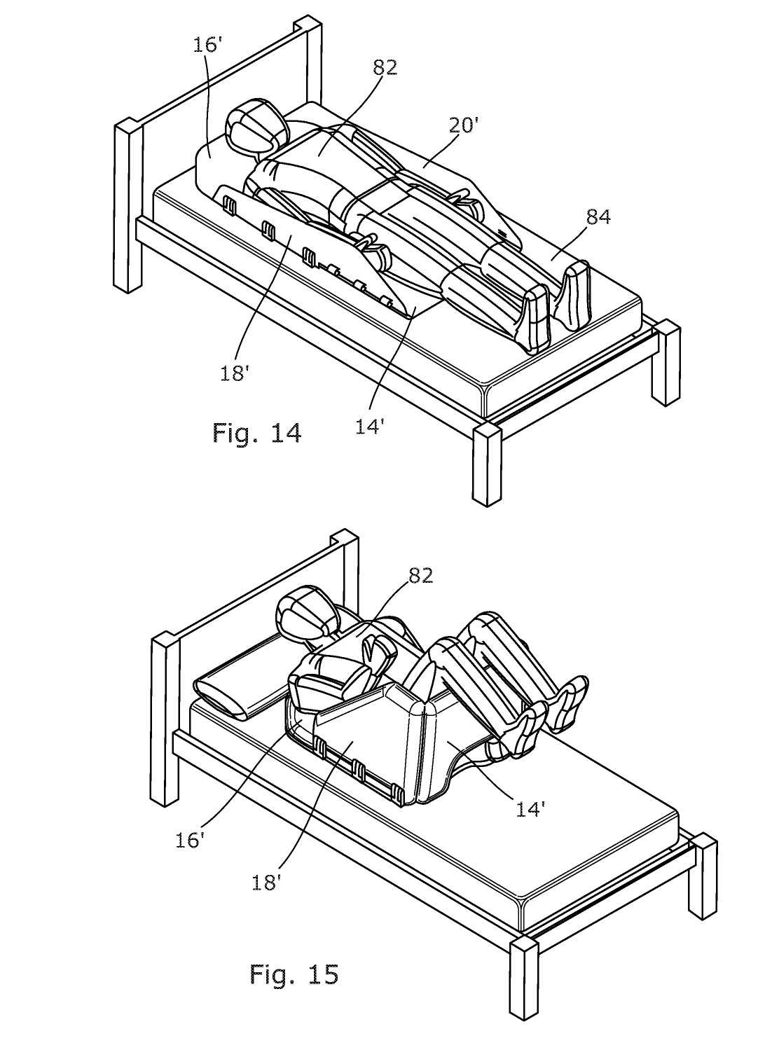

Once the back-support section 16′ and the seat section 14′ are in position, the side panel sections 18′, 20′ are manoeuvred up and around and the fasteners 30 engaged to attach each side panel section 18′, 20′ to its respective side of the back-support section 16′. The dimensions and the flexibility of the parts of the cradle allow the side panel sections 18′, 20′ to be attached to the back seat portion 16′ when the cradle is un-inflated whilst the patient remains in a supine position with their legs generally flat on the bed as shown, somewhat schematically, in FIG. 14. For example, the sides of the un-inflated back-support section are able to curve around the sides of the patient's torso whilst the sides of the un-inflated seat section are able to curve up around the sides of the patient's upper thigh/buttock region to enable the side panel sections to be attached whilst the patient's legs remain largely flat on the bed. The straps of the fasteners 30 at this stage are adjusted as short as possible so that the rear edges of the side panel sections 18′, 20′ are held close to the sides of the back-support section 16′.

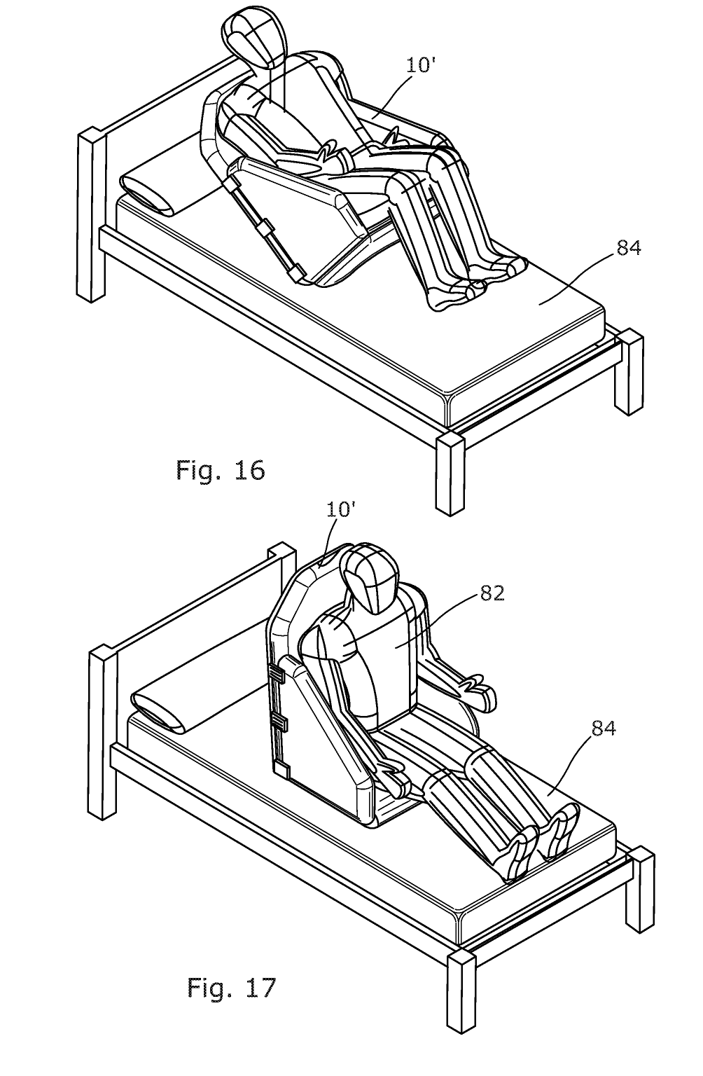

The cradle 10′ is now ready to be inflated using a portable air compressor (not shown) or other source of pressurised air connected to the inlet valves 36 of both parts of the cradle so that they are inflated simultaneously. Compressed air is introduced into both parts 32′, 34′ but as a significant proportion of the weight of the patient is concentrated on the seat section 14′ and the back-support section 16′, the side panel sections 18′, 20′ will tend to inflate first. This has the effect of drawing the back-support section 16′ forwardly (down the bed) so that the patient's buttocks are moved onto the seat section 14′. If the lower edge of the back-support section 16′ is bunched or folded about the patient's buttocks it will tend to creep under their buttocks/lower back. As the inflatable sections become more rigid and straighten out, the seat section 14′ and back-support sections are moved out of their common plane and become angled relative to one another to form a seat structure. In this embodiment, the weight of the patient holds the back-support member 16′ on the bed and the lower surface of the seat section is drawn off the bed such that the patient's upper legs are raised off the bed to place them in a “sitting position” but with the back-support section 16′ lying flat on the bed. This is illustrated in FIG. 15. As all the sections 14′, 16′, 18′, 20′ of the cradle become fully inflated, the seat section 14′ is drawn fully onto the patient's buttocks and held tight against the lower edge of the back-support section either side of the recess 56′. The patient is now supported in the cradle and the patient and cradle 10′ can be gently tilted forwardly to place them in an upright sitting position with the seat section 14′ on the upper surface of the bed mattress as shown in FIGS. 16 and 17.

It will be noted that at no time during the above-described procedures is it necessary for a care giver to manually lift the patient fully off the bed. It is only as the cradle 10′ inflates that the patient is raised off the bed surface. Where the seat section 14′ or back-support section have a recess, at least part of the patient's buttock region may remain in contact with the bed until the cradle is inflated.

In the method described above, the patient 82 remains on their back as the cradle is inflated. FIGS. 18 and 19 illustrate an alternative method using the lower leg support 70 in which the cradle is automatically raised to an upright sitting position as it inflates. In this alternative method, the lower leg support 70 is attached to the cradle 10′ after it has been placed about the patient and the two parts 32′, 34′ connected together but just prior to inflation. To attach the leg support 70, the side bars 74 are inserted into the hoops 72 on their respective sides and the sling 76 is attached to the forward ends of the side bars so that the sling is positioned beneath the patient's feet/lower calf region as illustrated in FIG. 18. At this stage, the patient remains in a supine position. The cradle is now inflated. As the cradle inflates, the weight of the patient's legs acting on the sling 76 of the leg support holds the seat section 14′ flat on the bed so that the back-support section 16′ and the side panel sections 18′, 20, are drawn up off the bed to an upright position as shown in FIG. 19. The carers can assist in tilting the cradle forward as it inflates. This pneumatically raises the patient into an upright sitting position automatically and ensures that the patient's legs remain largely horizontal to the support surface of the bed at all times. If necessary, additional weight could be added to the leg support 70. This might be required where the patient is a single or double amputee, for example, but may also be required in other circumstances. It will be appreciated that the seat section 14 could be held in contact with the bed by means other than a lower-leg support. For example, other arrangements to weigh down the seat section or of applying a force to it to hold it in contact with the bed can be adopted.

Once the cradle 10′ is fully inflated and in an upright position on the bed or other supporting surface, the patient is stably supported by the cradle in a suitable upright sitting position for transfer. It will be recognised that the above-described sequences can be reversed to position a patient in bed from an inflated cradle.

The cradle 10″ according to the third embodiment is placed about a patient and inflated in a similar manner but the main differences will now be described. Initially, the seat, back-support, and side panel sections 14″, 16″, 18″, 20″ are all separate from one another and in an un-inflated condition. With the patient lying in a supine position on a bed or other support, the seat section 14″ is positioned under their thigh/buttock region and the back-support section 16″ is positioned under their back making sure that the rear edge of seat section 14″ and lower edge of the back-support section 16″ are as close together as possible or overlapping. The patient can be manoeuvred and rolled in the usual way during this part of the procedure. The side panel sections 18″, 20″ are then attached between the seat section 14″ and the back-support section 16″, using the releasable fasteners 30a, 30b, and the fluid connectors 85a, 85b are assembled. The side panel sections may be attached sequentially or at the same time depending on how many carers are present.

Once the side panel sections 18″, 20″ have been securely connected and the fluid connections established, the cradle is inflated by connecting a source of pressurised air to the inlet valve 36. The cradle 10″ is inflated gradually so that the patient is moved into a sitting position safely and comfortably as the inflatable sections of the cradle inflate. If the cradle is used without a lower leg support 70, the patient will be placed in a sitting position but lying on their back and the cradle is then gently tipped forward to place the cradle and the patient in an upright sitting position with the seat section 14″ on the bed, as described above in relation to FIGS. 14 to 17. If the cradle 10″ is used with a leg support 70, then it will automatically tip forward gently as it is inflated, as described previously with regard to FIGS. 18 and 19. When the cradle is fully inflated the source of pressurised air is disconnected from the cradle and the restraints 88 secured in position. The patient is now ready to be manoeuvred with the cradle.

The above-described methods of positioning the un-inflated cradle about a patient are particularly suitable for patients with limited upper body strength who cannot sit upright on a bed unaided. However, where a patient is able to sit upright on a bed or where there are sufficient carers to assist in holding the patient upright, the method can be adapted so that the un-inflated cradle, or at least part of it, is fitted with the patient in an upright sitting position on the bed. For example, the seat section could be positioned beneath the patient whilst they are lying on the bed and the patient then sat up whilst the back-support section is located about their back and the side panel sections connected.

The inflatable patient cradle 10, 10′, 10″ is a highly flexible piece of apparatus that can be used in many different ways to support a patient for transfer and for treatment or care. The above-described methods are only examples of a number of different methods that can be used to place a patient in the cradle. However, in general, it is expected that the cradle will be positioned about the patient un-inflated, the side panel sections connected between the seat section and the back-support section as required, and the cradle subsequently inflated to define the seat structure in which the patient is supported and raised off the surface on which they are located. There are, however, various different ways in which the un-inflated cradle can be positioned about the patient, depending on the circumstances. For example, whilst the above methods describe the sections of the cradle being separated before the un-inflated cradle is positioned about the patient, it is not always necessary for any or all the parts to be separated. When fitting an un-inflated cradle 10, 10′, 10″ about a patient lying on a bed with good access from both sides, it may be possible to position the patient on the un-inflated cradle without separating any of the parts or by only disconnecting one of the side panel sections from at least one of the seat section and the back-support section. However, the ability to separate the various parts of the cradle does provide for flexibility in the way the cradle can be fitted and removed. For example, when fitting or removing the cradle about a patient sitting in a chair, it may be necessary that the seat section 14 is separated from the back-support section so that these can be positioned about the patient or removed independently of one another. Furthermore, the ability to remove the side panel sections, or at least move them out of the way about hinges, makes it possible for a patient to be moved sideways on or off the seat section and back-support sections.

In addition to providing flexibility in the way the cradle is fitted and used, forming the cradle with at least two separable parts also allows parts of the cradle to be removed for cleaning or repair and for a part of one cradle to be used with a part from another similar cradle. It also enables a cradle to be provided with different, interchangeable seat sections adapted for different applications. In one example, a seat section 14, 14′, 14″ could be provided with a toileting aperture and a user could choose whether to use a standard seat section with no toileting aperture or a seat section with a toileting aperture in the cradle.

Whilst an inflatable cradle having at least two separable parts has certain advantages in terms of flexibility of use, an inflatable patient cradle formed in one piece can also be useful. FIGS. 37 and 38 illustrate two further embodiments of an inflatable cradle 10′″, 10″“. These embodiments are similar to the embodiments 10 shown in FIGS. 1 to 4 and 10” FIGS. 5 to 8 respectively, except that they are formed as a single integral member in which the seat section 14′″, 14″″ and the back-support section 16′″, 16″″ are interconnected by a flexible hinge portion 45, similar to hinge portions 42, 42′ as described above. There is no recess along the rear edge of the seat section or the lower edge of the back-support section but the seat section is provided with a toileting aperture 47. A cradle 10′″, 10″″ in accordance with these embodiments can be positioned about a patient lying or sitting on a surface, such as a bed, using methods similar to those described above. To assist in this, at least one side panel section 18′″, 20′″; 18″″, 20″″ may be disconnected from the seat section or back-support section as appropriate. Once in place under the patient, the side panel sections are re-attached as required and the cradle inflated. With a patient supported in the inflated cradle in an upright sitting position, the cradle can be moved to place the patient over a toilet or commode and the patient toileted. After toileting, the procedure can be reversed to return the patient to bed.

A toileting aperture 47 similar to that shown in FIGS. 37 and 38 can be adopted in the seat sections 14, 14′, 14″ of any of the embodiments of the cradle 10, 10′, 10″ previously described. Where a toileting aperture 47 is adopted, the seat section may not have a recess along its rear edge to ensure there is sufficient area to lift and support the patient. For use with a seat section having a toileting aperture 47, a replaceable protective membrane or cover may be placed between the patient and the seat section and which extends into the toileting aperture to reduce soiling of the seat section.

In order to stably hold a patient in an upright sitting position, the back-support section must extend to a suitable height, which will typically be at least up to shoulder height for the intended user but may also extend to head height and the back-support section could incorporate a head rest portion 16a as illustrated in FIGS. 37 and 38. The side panel sections must extend sufficiently far up the back-support section that they hold the back-support section upright over its full height. Typically, the patient's arms are constrained within the side panel sections when the cradle is inflated. In addition to acting in tension to hold the back-support section upright, the side panel sections contact both the seat section and the back-support section to act in compression to prevent the back-support section being tipped forwardly beyond the vertical. This is helpful when a patient is being transferred in the cradle so that they are not inadvertently tipped forward out of the cradle.

In order to stably support a patient in an upright sitting position and in order to be able to lift the patient dynamically as the cradle inflates, the cradle must be inflated to a suitably high pressure to provide the required lift and rigidity. The pressure required to lift a patient depends on their weight and the area of the inflatable section which is doing the lifting, which will either be the seat section or the back-support section. In use to lift a patient having a weight in the region of 95 kg to 127 kg, which is a typical weight range for adults in a care home or hospital, it has been found in one embodiment that the cradle would typically be inflated to a pressure of around 27 kPa to 34 kPa. However, a lower pressure could potentially be used if the surface area of the inflatable sections is increased, provided the inflatable cradle is sufficiently rigid to support the patient once inflated. The inflatable sections of the cradle should be constructed to be able to withstand the maximum pressure required for its intended use.

With a patient 82 supported in an upright sitting position in the inflated cradle 10, 10′, 10″, 10′″, 10″″, the cradle can be manoeuvred across a surface manually, perhaps with the assistance of a glide sheet or other low friction material placed between the seat section 14′ and the surface. The cradle 10, 10′, 10″, 10′″, 10″″ could also be provided with attachments to enable it to be lifted by means of a crane or hoist, with the patient safely on-board. A detachable strap could be provided to enable a carer to pull the cradle along.

In accordance with a further aspect of the invention, the cradle is used in conjunction with a variety of apparatus to be described below which comprise rollers over which the cradle can be moved manually with relative ease and safety to form a highly flexible and easy-to-use modular system for moving patients. In the following description and drawings, reference will be made primarily to the cradle 10′ according to the second embodiment. However, it should be appreciated that the apparatus may be used with a cradle 10, 10′, 10″, 10′″, 10″″ in accordance with any of the embodiments described herein or falling within the scope of the accompanying claims.

FIG. 20 illustrates a first apparatus in the form of a roller transfer assembly 90 which can be used to move an inflated cradle 10′ with a patient on-board across a surface and is particularly suitable for manoeuvring the patient laterally across a bed in order to get them on or off a bed. The roller transfer assembly has a number of elongate, roller batons 92 aligned parallel to one another. Each roller baton 92 includes an elongate support 94 to which are rotatably mounted a number of rollers 96. The rollers 96 are arranged to rotate about axes which extend perpendicular (transversely) to the longitudinal extent of the elongate support 94. Conveniently, the elongate support 94 is in the form of a channel member with the rollers mounted between opposed side walls of the channel member. However, other supporting structures could be adopted. The roller batons 92 are interconnected by one or more cross-members in the form of rigid base-plates 98 to maintain their relative spacing. The base-plates 98 each have an elongate section 100 to which the roller batons 92 are connected and an enlarged head portion 102. The head portion 102 projects outwardly beyond the rearmost roller baton and its large surface area helps to spread the load, which is particularly beneficial when using the assembly on a relatively soft surface such as a bed mattress. However, the head portion 102 is not essential and could be omitted. The rollers 96 define a low rolling resistance support surface across which the cradle 10′ can be moved from one end of the roller batons 92 to the other. The roller transfer assembly 90 can be dimensioned as required depending on the desired application. For example, for use in transferring a patient across a bed, the roller batons 92 can be dimensioned so as to extend across the full width of the bed. Roller transfer assemblies 90 could be made in suitable sizes for use with standard bed sizes or other applications. Alternatively, roller transfer assembles 90 may be releasably inter-connectable with one another to enable a combined assembly of desired length to be produced.

When in use, the roller batons 92 and the base-plates 98 form a generally rigid frame structure. However, the roller transfer assembly 90 can be configured so that it can be taken apart or folded when not in use for ease of storage/transportation. For example, the base-plates 98 could be formed in a number of rigid parts that can be separated. Alternatively, at least one roller baton 92 may be attached to the base-plates 98 by means of releasable interconnections or fasteners.

In use, the roller transfer assembly 90 is positioned between the seat portion 14′ of the inflated cradle 10′ and the support surface across which the cradle is to be moved, with the roller batons 92 extending in a transverse direction of the cradle so that the cradle can be rolled in a sideways direction of the cradle along the rollers 96. The roller transfer assembly 90 is typically positioned underneath the cradle 10′ after it has been inflated. Where the cradle is inflated without the use of a leg support 70 so that the back-support section 16′ remains on the surface as shown in FIG. 15, the roller transfer assembly 90 can be positioned on the surface in front of the cradle prior to tipping the cradle forwardly so that when it is tipped forward, the seat portion 14′ comes down on the roller transfer assembly as illustrated in FIG. 21.

Where the leg support 70 is used so that the cradle 10′ is inflated to an upright position as shown in FIG. 19, it will be necessary to raise the cradle off the surface to allow the roller transfer assembly 90 to be inserted. There are numerous ways in which this can be achieved. FIG. 22 illustrates the use of a pair of pneumatically-inflatable soft-walled beams 104. The beams 104 are positioned in an un-inflated condition under the side bars 74, with one beam in front and one beam behind the cradle. The beams 104 are inflated to raise the cradle 10′ off the surface of the bed allowing the roller transfer assembly 90 to be positioned underneath the seat portion 14′. The beams 104 are then deflated to lower the seat portion 14′ onto the roller transfer assembly 90 and then removed. In this arrangement, the side bars 74 extend rearwardly beyond the back-support section 16′ of the cradle. Once the cradle 10′ has been positioned on the roller transfer assembly 90, the leg support 70, including the side bars 74, can be removed for ease of manoeuvring the cradle. However, in some cases it may be desirable to support the patient's legs as they are transferred in the cradle. In this case, the side bars 74 may have rearward extension portions that project beyond the rear face of the back-support section and which can be removed after the cradle has been lowered onto the roller transfer assembly 90, whilst forward portions of the side bars 74 remain in position to form the leg support.

Other arrangements for raising the cradle 10′ to allow the roller transfer assembly 90 to be placed in position can be used. For example, a mechanical cam arrangement may be attached to the side bars 74 and used to lever the cradle 10′ off the surface.

Once in position on the roller transfer assembly 90, the cradle 10′ can be moved along the assembly 90 across the rollers to the edge of the bed. The use of a plurality of roller batons 92 spaced apart has the advantage that the material of the seat portion 14′ will tend to engage front and rear edges to prevent the cradle easily sliding off the roller transfer assembly 90 to the front or rear, whilst allowing easy movement along the length of the roller batons. However, this is not always essential and the roller batons 92 could be positioned adjacent one another to form a largely continuous rolling surface. Indeed, rather than using a number of separate roller batons 92, a single set of longer rollers could be used mounted in a suitable support frame, such as a channel member. Furthermore, whilst the use of rollers rotatable about a single axis is advantageous in controlling the direction of movement of the cradle, other arrangements for producing a low friction supporting surface could be used. For example, the rollers could be spherical or part spherical. Alternatively, the rollers could be replaced by a moving belt or track. In this case, the belt or track could be driven by means of a motor or the like to move the cradle.

The roller transfer assembly 90 may include a mechanism to prevent a cradle from unintentionally rolling off an end of the roller batons. As illustrated schematically in FIG. 20, the assembly may include a safety buffer or barrier 105 releasably attachable to one end of the roller batons 92 so as to prevent a cradle from unintentionally rolling off the assembly at that end. A safety buffer 105 could be provided at both ends when the cradle is initially positioned on the assembly, with one buffer being removed only as the cradle is guided to that end and where it is intended that the cradle be moved off the roller assembly.

The roller transfer assembly 90 can be made in standard sizes and one or more roller transfer assemblies can be releasably connected together to form a combined transfer assembly of increased size.

FIG. 39 illustrates a modification in which a number of elongate, articulated, finger-like members 106 are attached to an end of a roller transfer assembly 90 to assist in moving a patient on to and off from the roller transfer assembly. Each member 106 has a number of channel sections 107 pivotally connected to one another about parallel axes and each channel section has a roller 108 pivotally mounted for rotation about an axis with is parallel to the axes of rotation between the adjacent channel sections 107. Each adjacent pair of channel sections 107 are pivotally connected by means of a pin 109 for rotation relative to one another. Each member 106 is releasably attachable to the roller transfer assembly 90 at a proximal end and has a roller 108a at its distal end which is smaller in diameter the remaining rollers 107. In use, a number of the articulated members 106 are attached to a roller transfer assembly at one end with the axes of the rollers 108 in the members parallel to the axes of rotation of the rollers 96 on the transfer assembly. The members 106 form a flexible and tapered roller surface over which an air cradle with a patient on-board can be moved on or off the roller transfer assembly. More than one roller 108 can be provided in each channel section and the rollers 108 may taper in size from the proximal end to the distal end.

FIGS. 40 to 42 illustrate a further embodiment of a bi-directional roller transfer assembly 90′ which can be used to move a patient in either one or two directions. The roller transfer assembly 90′ has a fixed main frame 300 which is square or rectangular in shape, though other shapes are possible. Mounted to the main frame is a first set of rollers 96A which are all rotatable about axes parallel to one another in a first direction. The upper surfaces of the rollers 96A in the first set are all located in a common first plane. The first set of rollers 96A are mounted in a first set of elongate roller batons 92A having channel members 94A in which the rollers are mounted and which are similar to the roller batons 92 described above. The roller batons 92A in the first set are spaced apart across the main frame 300. Each roller baton 92A is mounted to the main frame by means of four links 302 pivotally connected to the main frame at one end and to the channel member 94A at the other end. The links 302 allow each roller baton 92A in the first set to move between a raised position as shown in FIG. 41 and a lowered position as shown in FIG. 40 whilst staying parallel to the main frame. Other arrangement for movably mounting the roller batons 92A can be adopted. The roller batons 92A in the first set are interconnected at one end by a cross member 304 so that the roller batons 92A in the first set form a movable roller baton unit 305 which can be raised and lowered as a single entity.

A mechanism 306 is provided for selectively raising and lowering the movable roller baton unit 305 and holding it in a raised or lowered position. The mechanism includes an elongate shaft 307 having an external thread. The shaft is in threaded engagement with a nut 308 mounted to the cross member 304. The nut 308 is mounted to the cross member so that it can pivot about an axis transverse to the longitudinal axis of the shaft 307 but is otherwise captive on the cross member. An end of the shaft 307 passes through a support 309 captivity mounted in the main frame 300. The support 309 is pivotally mounted to the main frame for rotation about an axis transverse to the longitudinal axis of the shaft in a similar manner to the nut 308 but has a plain bore to allow the shaft 307 to rotate about its longitudinal axis within the support. A ratchet handle 310 engages a free end of the shaft 307 which protrudes from the support 309 on the side opposite from the nut 308. The ratchet handle 310 can be used to selectively rotate the shaft in either direction. Rotating the shaft 307 in a first direction causes the nut 308 to move along the length of the shaft 307 towards the ratchet handle drawing the movable roller baton unit 305 towards the ratchet handle and moving it to the raised position. Rotating the shaft 307 in the opposite direction moves the nut 308 away from the ratchet handle and so allows the movable roller baton unit 305 to move back to the lowered position. However, it will be appreciated that a wide variety of other mechanisms could be used to raise and lower the movable roller baton assembly 305.

A second set of rollers 96B is mounted to the main frame. The rollers 96B in the second set are arranged to rotate about axes that are parallel to one another but not to the axes of rotation of the rollers 96A in the first set. In this embodiment, the rollers 96B in the second set rotate about axes that are aligned at 90 degrees to the axes of rotation of the rollers 96A in the first set. The rollers in the second set are mounted to the main fame in roller batons 92B that are fixedly attached to the main frame. The rollers 96B in the second set are arranged in rows spaced apart across the main frame. The rollers 96B in the second set are interspersed between the rollers 96A in the first set over the area of the main frame so that the rollers in either set form a supporting surface on which a patient in an inflated air cradle can be moved. In this case, some of the roller batons 92B in the second set are divided into roller baton segments which are located in the spaces between the roller batons 92A in the first set. The upper surfaces of the rollers 96B in the second set are located in a second common plane. The roller transfer assembly 90′ is configured so that when the movable roller baton unit 305 is in its lowered position, the upper surfaces of the rollers 96A in the first set are below the upper surfaces of the rollers 96B in the second set and when the movable roller baton unit 305 is in its raised position, the upper surfaces of the rollers 96A in the first set are above the upper surfaces of the rollers 96B in the second set. When the movable roller baton unit 305 is in its lowered position, a patient can be moved across the roller transfer assembly 90′ in a first direction supported on the rollers 96B in the second set. Conversely, when the movable roller baton unit 305 is in its raised position a patient can be moved across the roller transfer assembly 90′ in a second direction supported on the rollers 96A in the first set. The bi-directional roller transfer assembly 90′ can thus be used to transfer a patient in either one of two directions and could be used to change the direction of transfer in use by adjusting the movable roller baton unit 305 whilst a patient is supported on the roller transfer assembly 90′. For example, a bi-directional roller transfer assembly 90′ can be connected between two standard uni-directional roller transfer assemblies 90 which are aligned at 90 degrees to one another. A patient in an air cradle is placed on a first of the uni-directional roller transfer assemblies 90 and moved along it in a first direction onto the bi-directional roller transfer assembly 90′. The movable roller baton unit 305 is then moved either from its lower position to its raised position as required so that the cradle can be moved in a second direction onto the other uni-directional roller transfer assembly 90 which is aligned with the second direction.

The roller transfer assembly in accordance with either embodiment 90, 90′ provides a simple to use, lightweight and low cost arrangement for moving a patient supported in an inflated cradle 10, 10′, 10″, according to the invention, across a surface. It is particularly suitable for moving the patient between the edge and the centre of a bed. However, it can be used on any suitable surface. The roller frame assembly 90 could, for example, be used on a chair or patient trolley to move a patient on or off the chair or trolley or to reposition them whilst supported in an inflated cradle 10, 10′, 10″. The roller transfer assembly 90, 90′ can also be used without the air cradle. For example, where a patient has sufficient upper body strength they could be moved along a roller transfer assembly whilst seated on a pneumatic or other cushion.

Often it is necessary or desirable to be able to move a patient between different locations. FIGS. 23 to 25 illustrate a mobile transfer unit 110 which can be used in conjunction with the inflatable cradle 10, 10′, 10″, 10′″, 10″″ and/or the roller transfer assembly 90, 90′.

The mobile transfer unit 110 includes a chassis 112 having wheels or castors or other ground-engaging members 114 that enable the unit to be moved over the ground or a floor surface in a controlled manner and a releasable braking system 115 which can be selectively engaged to prevent it from rolling unintentionally. The mobile transfer unit 110 has a height-adjustable platform 118 mounted to the chassis. Any suitable mechanism can be used to raise and lower the platform 118 and may include a powered actuator such as a hydraulic or pneumatic actuator or electrical motor. In one embodiment, a scissor-type mechanism powered by an electric motor is used to raise and lower the platform 118. Ideally, the platform can be lowered to a height measured at its upper surface 120 of about 38 cm (15 inches) or less and raised to a height of 64 cm (25 inches) or more. This range of movement will allow the system to cope with most transfer situations.

Four roller batons 92 are located in the platform 118. The batons 92 extend transversely across the platform 118. The roller batons 92 are similar to those used in the roller transfer assembly 90, each comprising a number of rollers 96 mounted in a rigid elongate support 94 which may be in the form of a channel member. The roller batons 92 are received in apertures 122 in the surface of the platform 118 but with the upper surface of the rollers 96 just above the upper surface 120 of the platform 118. The rollers 96 are aligned parallel to one another and rotate about axes which extend from the front to the rear of the platform. Whilst the present embodiment has four roller batons 92, the number of roller batons can be varied as desired. The roller batons 92 may be mounted so that they can be moved between a raised, transfer position in which the upper surface of the rollers is above the upper surface 120 of the platform and a lowered position in which the rollers are recessed wholly below the upper surface 120 of the platform 118. This would allow the roller batons 92 to be raised when the patient is being moved on or off the mobile transfer unit 110 and lowered when the patient is on-board to provide for greater comfort. Alternatively, the roller batons 92 could be stationary and support regions between and/or about the batons can be raised or lowered. Any suitable mechanism for raising and lowering the roller batons 92 or support regions can be adopted. It will also be appreciated that the rollers need not be provided in roller batons but could be mounted to the platform 118 by any suitable means.

The mobile transfer unit 110 has a handle 124 for manoeuvring the unit, a back rest 126 removably mountable at the rear of the platform, and side restraints 128 removably mounted on either side of the platform 118. The platform 118 may have a series of apertures in which the backrest 126, side restraints 128 and other ancillary equipment can be mounted. The unit 110 may also have a movable leg support panel 130 which can be selectively raised as shown in FIG. 24 to support the legs of a person in a raised position whilst being transported on the transfer unit 110 and/or whilst being moved on or off the unit. The leg support panel 130 may be split to provide separately movable panel portions for each leg. This would enable either leg to be selectively supported in a raised position. In this case a catch arrangement may be provided to enable the two panel portions to be locked together so that they can be raised and lowered as a single unit if desired or unlocked for independent actuation.

As illustrated in FIGS. 26 and 27, the mobile transfer unit 110 can be used in conjunction with the roller transfer assembly 90 to move a person onto or off from a bed, or other surface, whilst supported in an inflated cradle 10′. With the patient supported in an upright sitting position in the inflated cradle 10′ and the cradle positioned on top of the roller transfer assembly 90 extending transversely across the bed, the mobile transfer unit 110 is positioned with one side adjacent a side of the bed and with the platform 118 in line with the roller transfer assembly 90 and the cradle 10′. The brakes are applied and the height of the platform 118 is adjusted to bring the top of the rollers 96 on the mobile unit 110 broadly into the same plane as the top of the rollers 96 in the roller transfer assembly 90. The side restraint 128 adjacent the bed is removed, or raised so as to be out of the way, to allow access to the platform 118, and the leg support panel 130 raised. As illustrated schematically, a safety buffer 105 may be attached to the roller transfer assembly 90 at the end distal from the mobile transfer unit 110 to ensure the cradle does not unintentionally roll off the assembly at that end. A further safety buffer could be attached to the roller transfer assembly at the end proximal to the mobile transfer unit when the cradle 10′ is positioned on the assembly 90 and only removed when the mobile transfer unit 110 is in position and it is safe to move the cradle from the roller transfer assembly and on to the mobile transfer unit. With the mobile transfer unit 110 in position and adjusted as required, the cradle 10′ is moved laterally along the roller transfer assembly 90 towards and onto the rollers 96 in the platform 118. Once the cradle 10′ is in position and fully supported on the platform 118, the side restraint 128 adjacent the bed is replaced to ensure the cradle 10′ cannot slide off the platform to the side. The leg support panel 130 can be lowered if desired and the height of the platform 118 adjusted as required so that the patient can be moved to another location on the mobile transfer unit whilst stably supported in the inflated cradle. The patient could be moved to a new bed or subsequently returned to the same bed where the above-described sequences are reversed in order to place the patient in the middle of the bed. Similar procedures can be used to move a patient between the mobile transfer unit 110 and any suitable, generally horizontal support surface having a height within the range of adjustment of the platform 118.

Use of the mobile transfer unit 110 provides a high level of flexibility to the system, allowing a patient to be safely and comfortably moved between different locations whilst supported in the inflatable cradle 10, 10′, 10″. The ability to adjust the height of the platform 118, enables a patient 82 to be transferred between apparatus having support surfaces at differing heights, say between a bed and a chair.

The mobile transfer unit 110 can be adapted to enable a patient to be toileted whilst on the unit by providing a toileting aperture 132 in a central region of the platform 118 as illustrated in FIG. 28. This may require that at least the two central roller batons are split into parts either side of the aperture. The chassis 112 and the height-adjusting mechanism are configured so that the unit can be manoeuvred backwards over a toilet when the platform is raised to a suitable height. This may require that the height-adjusting mechanism is provided in two parts, one on either side of the unit. The modified mobile transfer unit 110 with a toileting aperture 132 is particularly but not exclusively suited to use with a cradle 10, 10″ in accordance with the first and third embodiments having a seat section 14, 14″ which can be removed without having to deflate the back-support and side panel sections or where the seat section has a toileting aperture. With a patient supported in the inflated cradle 10, 10′, 10″, 10′″, 10″″ on the mobile transfer unit 110, the unit is manoeuvred backwards over a toilet so that the toileting aperture is aligned with the toilet bowl. Where the seat section has a toileting aperture, the patient can be toileted whilst supported in the inflated cradle. Alternatively, where the seat section is removable, the seat section 14, 14″ is disconnected from the side panel sections 18, 20, 18″, 20″, deflated and fully or partially removed to allow the patient access to the toileting aperture.

After toileting, the seat section 14, 14″ is repositioned, attached to the side panel sections 18, 20, 18″, 20″ and re-inflated. Throughout this process, the patient is supported by the back-support section and the side panel sections of the cradle which remain inflated. However, the modified mobile transfer unit 110 could be used with a cradle in accordance with any of the embodiments disclosed herein.

Various apparatus incorporating a low friction support surface configured so that a patient supported in an inflated cradle 10, 10′, 10″, 10′″, 10″″ can be moved easily between the support surface and the mobile transfer unit 110 can be provided as part of an integrated patient handling system. Such equipment might include chairs, trolleys and toileting supports, for example. The low friction support surface may be provided by rollers, which may be provided in roller batons 92 similar to those used in the roller transfer assembly 90, 90′ and the mobile transfer unit 110 as described above. In an advantageous arrangement, the apparatus will be adjustable between a transfer configuration in which the upper surfaces of the rollers are positioned above a conventional (non-rolling) supporting surface for use in transferring the patient on and off the apparatus and a non-transfer configuration in which the rollers are located below the conventional supporting surface.

FIGS. 29 and 30 illustrate an example of a chair 140 having legs 141, a padded seat 142 defining an upper supporting surface 144 and a padded back rest 146. Located in spaced elongate slots 148 which extend transversely across most of the width of the seat are a pair of roller batons 92. The roller batons 92 each have an elongate supporting structure 94 in which a plurality of rollers 96 are rotatably mounted. The roller batons 92 can be moved between a raised, transfer position as shown in FIG. 29 in which the upper surface regions of the rollers 96 are located above the upper surface 144 of the seat 142 and a lowered position in which the rollers 96 are spaced below the upper surface 144 of the seat as shown in FIG. 30. With the roller batons 92 locked in the raised position, a patient supported in an inflated cradle 10, 10′, 10″, 10′″, 10″″ can be easily moved onto or off from the seat in a lateral direction from one side or the other in a manner similar to that described above in relation to the mobile transfer unit 110. Typically the chair 140 would be used in conjunction with the mobile transfer unit 110 which can be positioned adjacent one side of the chair and the platform 118 adjusted to a suitable height to allow a patient supported in an inflated cradle 10, 10′, 10″, 10′″, 10″″ to be moved between the mobile transfer unit 110 and the chair 140 by sliding the cradle across the rollers on the mobile transfer unit platform 118 and the chair seat. Where a patient is being moved on to the chair 140, the roller batons 92 can be lowered once the cradle 10, 10′, 10″, 10′″, 10″″ is in position on the seat to allow the patient to sit comfortably on the chair 140. Where a patient is able to support themselves in a sitting position on the chair, the cradle 10, 10′, 10″, 10′″, 10″″ can be deflated, the parts separated where appropriate and removed to leave the patient sitting directly on the seat 142 of the chair. To subsequently move the patient off the chair, the parts of the cradle are positioned about the patient when un-inflated and joined together. The cradle is inflated to lift the patient off the surface of the seat and support them in an upright sitting position. The roller batons 92 are then raised to allow the patient to be transferred off the seat in the inflated cradle, for example onto a mobile transfer unit 110. The procedure for fitting the cradle 10, 10′, 10″, 10′″, 10″″ will be similar to that described above but suitably modified to allow for the patient being in an upright sitting position. The chair 140 may be provided with arm rests (not shown) which can be selectively removed to allow for transfer of the patient onto or off from the chair.

Any suitable mechanism for raising and lowering the roller batons 92 can be adopted and the mechanism could be powered. FIG. 31 illustrates one possible arrangement for manually raising and lowering a pair of roller batons 92 which can be adapted for use in any suitable apparatus. An adjustable roller baton assembly 150 has a frame 152 which can be mounted to a supporting structure 154, say of a chair 140 or any other apparatus. The frame 152 includes a pair of spaced, rigid lateral frame members 156 which are suitably shaped for attachment to the supporting structure 154. Two spaced, rigid cross-members 158 extend between the lateral frame members 156 to maintain them in a fixed spaced relation. First and second roller batons 92 are attached to the frame 152 for movement between raised and lowered positions. The roller batons 92 are similar to those described previously and comprise an elongate support member 94, which may be in the form of a channel member, in which are rotatably mounted a number of rollers 96 spaced along its length. The roller batons can be made in any suitable length for a desired application and the frame 152 constructed accordingly. The roller batons 92 are spaced apart and aligned parallel to one another and the lateral frame members so as to extend transversally relative to the seat 142 or other supporting surface in use. The elongate support member 94 of each roller baton 92 is connected at either end with a respective one of the cross-members 158 by one or more pivoting links 160. The links 160 are each pivotally connected with both the elongate support member 94 and the respective cross member 158 and are arranged so that the roller baton 92, the links 160 and the frame 152 define a four bar linkage or parallelogram. This arrangement allows the roller batons 92 to be moved between a lowered position as shown in FIG. 31 and a raised position by moving the baton 92 in a lengthwise direction of the baton whilst the batons remain substantially horizontal.

A winding mechanism 164 is provided at one end of the frame 152 for moving the roller batons 92 lengthwise between raised and lowered positions. The winding mechanism 164 includes a winding bar 166 rotationally mounted to the frame 152 and aligned parallel to the cross-members 168, that is to say perpendicular to the longitudinal direction of the roller batons 92. A handle 168 is attached to the winding bar 166 at one end to allow the bar to be manually rotated. The winding bar 166 is connected to each roller baton 92 by a strap 170. Each strap 170 is attached at one end to an end of the elongate support member 94 of its respective roller baton 92 and passes over a bobbin 172 rotatably mounted to the frame 152. The other end of each strap 170 is secured to the winding bar 166. Rotating the winding bar 166 in a first direction, clockwise as shown, by use of the handle causes the straps 170 to be wound on to the winding bar, pulling the roller batons 92 to the raised position as the links 160 pivot. To lower the roller batons 92, the winding bar 166 is rotated in the opposite direction to unwind the straps from the winding bar 166. The roller batons 92 may be biased away from the winding mechanism to return to the lowered position or the arrangement may be configured so that when the roller batons are in the raised position, the links 160 do not reach the vertical so that the weight of the roller batons returns them to the lowered position when the straps 170 are un-wound. A releasable locking mechanism to hold the roller batons 92 in the raised position is provided. This may take the form of a ratchet arrangement operative on the winding bar 166 which allows it to rotate in the first direction but prevents it from rotating in the opposite direction unless manually released. The winding mechanism 164 or something similar could be adopted for use in the bi-directional roller transfer assembly 90′ described above in place of the ratchet mechanism 306.

FIGS. 43 and 44 illustrate an alternative adjustable roller baton assembly 150′. The adjustable roller baton assembly 150′ in this embodiment has an adjustment mechanism which is similar to that used in the bi-directional roller transfer assembly 90′ described above, to which the reader should refer. It includes a main frame 152′ to which four roller batons 92 are mounted for movement between raised and lowered positions by means of links 160. The roller batons 92 are inter-connected at one end by a cross member 153 to form a movable roller baton unit 155 which can be raised or lowered as a single entity. A mechanism 306 including a ratchet-operated screw 307 and which is similar to that described above in relation to the bi-directional roller transfer assembly 90′ is used to selectively move the roller baton unit 155 between raised and lowered positions. However, other mechanisms could be used, such as the winding mechanism 164 described above.

The roller batons 92 are aligned parallel with one another and spaced apart across the main frame. The roller batons 92 are located in recess in a seat member 157 fixedly mounted to the main frame. When the movable roller baton unit 155 is raised, the upper surfaces of the rollers 96 are located in a plane above the upper surface of the seat member 157 and when it is lowered, the rollers 96 are located below the upper surface of the seat member. The seat member 157 may be cushioned to form a comfortable seating surface when the roller batons are lowered. However, the seat member 157 can also be used to provide a conventional non-rolling supporting surface on which the seat member of the air cradle or some other cushioning device rests.

FIGS. 45 and 46 illustrate a still further alternative adjustable roller baton assembly 150″. This embodiment is similar to the previous embodiment except that in this case to roller batons 92 are fixedly mounted to the main frame 152″ and a number of seat members 159 are mounted to the main frame for movement between raised and lowered positions. This is, in essence, the inverse of the previous embodiment. Each roller baton is sandwiched between a pair of seat members 159. The seat members 159 are elongate and each may include a cushioned support mounted in a channel member which is attached to the main frame by links 160 in a similar manner to the roller batons of the previous embodiment. The seat members 159 are interconnected along one end by a cross member to form a seat member unit 155′ which is raised and lowered by a mechanism 306. The mechanism 306 in this embodiment is the same as that described above in the previous embodiment and that used in the bi-directional roller transfer assembly 90′. The reader should refer to the previous descriptions for details. However, other suitable mechanisms could be used to move the seat member unit 155′ between its raised and lowered positions. When the seat members 159 are raised, their upper surfaces are located above the upper surfaces of the rollers 96 and when they are lowered, their upper surfaces are located below the upper surfaces of the rollers.

Adjustable roller baton assemblies 150, 150′, 150″ can be supplied as standard units to furniture manufacturers for incorporation in a range of different furniture items for use as part of a patient handling apparatus. This might include a range of chairs, sofas and the like. An adjustable roller baton assembly 150, 150′, 150″ or something similar could be adapted for use in the mobile transfer unit 110. The adjustable roller baton assembly 150, 150′, 150″ can be modified to vary the number of roller batons 92 as required. For example, the assembly might have only a single roller baton 92 or up to as many as five or more. Furthermore, the rollers need not be held in roller batons but could be mounted by any suitable arrangement.

Whilst the adjustable roller baton assemblies 150, 150′, 150″ described above are particularly suitable for use with an inflatable patient transfer cradle, they can be used with a patient supported on a simple pneumatic cushion or other similar seating pad.

FIG. 32 illustrates a toileting support 180 which can be used as part of a system or apparatus for handling a patient. The toileting support 180 is in the form of a chair-like structure having a seat 182 and a back rest 184. The seat 182 is mounted on four legs 185, which are height-adjustable. Rolling ground-engaging members 186, which may be in the form of wheels or castors, are attached to the lower ends of the legs so that the support can be moved across the ground or a floor. A toileting aperture 187 is provided in a central region of the seat and a side restraint 188 is provided along one side of the seat. The side restraint 188 may also act as an arm rest and both the side restraint 188 and the back rest 184 may be detachably mounted. Located on the edge of the seat along the side opposite from the side restraint 188 is a longitudinal, elongate roller assembly 190, having one or more rollers 192 rotatable about an axis extending in a longitudinal direction of the seat, that is to say from the front to the rear of the seat. The upper surface of the roller or rollers 192 is located slightly above the upper surface 194 of the seat. Between the toileting aperture 187 and a front edge 196 of the seat is a transverse roller assembly in the form of a roller baton 92 which extends parallel to the front edge of the seat. Whilst the roller baton 92 extends transversely, the rollers 96 in the baton are mounted for rotation about axes which extend in the longitudinal direction of the seat (that is from front to back) and so rotate in the same direction as the rollers 192 of the longitudinal roller assembly 190. The roller baton 92 is mounted in an elongate slot 198 in the seat and can be moved between a raised position as shown, in which the upper surfaces of the rollers 96 are located above the upper surface 194 of the seat and a lowered position in which the rollers 96 are wholly positioned below the upper surface of the seat. The roller baton 92 is mounted to the seat by means of spaced pivotal links 200 so as to form a parallelogram type four bar linkage with the seat in a manner similar to the roller batons 92 in the adjustable roller baton assembly 150 described above. A winding mechanism 202 similar to that used in the adjustable roller baton assembly 150 is mounted on one side of the seat and has a strap 204 attached to the support member 94 at one end of the roller baton assembly to selectively raise and lower the roller baton assembly 92. The winding mechanism 202 works in substantially the same way as the winding mechanism 164 described above in relation to the adjustable roller baton assembly 150 and so will not be described again further. It will be appreciated that in any given winding mechanism for use with a roller baton 92, the positions of the winding bar and bobbin can be varied to suit different applications.

In use, a patient can be transferred onto the toileting support 180 whilst supported in an inflated cradle 10′. It is expected that transfer will be from a mobile transfer unit 110 but transfer could be effected in different ways depending on the circumstances. Where a mobile transfer unit 110 is used, the unit 110 is positioned adjacent the side of the toileting support 180 with the longitudinal roller assembly 190. The roller baton 92 is moved to the raised position and locked. With the platform 118 of the mobile transfer unit 110 adjusted to a suitable height to match that of the seat 182, the cradle is moved from the mobile transfer unit 110 across onto the seat 182 moving over the rollers 96, 192 of the roller assembly 190 and the roller baton 92. Once the cradle 10′ is correctly located above the seat 182, the roller baton 92 is lowered so that the seat portion 14′ of the cradle rests on top of the seat 182. The mobile transfer unit 110 can be moved away and the toileting support 180 moved into position as required over a toilet. For toileting, the cradle 10, 10′, 10″, 10′″, 10″″ can be deflated and at least the seat portion 14, 14′, 14″ fully or partially removed. However, where the seat section has a toileting aperture 147, then the seat section need not be deflated or removed. These procedures can be reversed after toileting is completed to transfer the patient back onto the mobile transfer unit 110 from which they can be moved back to bed or to a chair or elsewhere as desired.

FIGS. 33 to 36 illustrate how an inflatable patient transfer cradle 10, 10′, 10″, 10′″, 10″″ can be used to lift a person from the floor together with a floor-lift device 210. The floor-lift device 210 comprises a frame having raised side bars 212 interconnected by a number of rigid cross-members 214, three in this case. The cross-members angle downwardly from each of the side bars to a central region in which they extend generally horizontally to define a recessed base region 216. The base region 216 and raised side bars 212 define a basket for receiving the seat section 14′ of an inflated cradle 10′. Rolling ground-engaging members 218, which may be in the form of wheels or castors, are attached to forward and rear ends of each of the side bars so that the device can be rolled along the ground or floor. Some or all of the rolling ground-engaging members 218 are provided with releasable brake mechanisms 220. The device is configured so that the central base region 216 is located as close to the ground or floor surface on which the device is standing as possible whilst maintaining a working clearance. A pneumatically-inflatable bellows lift 222 is positioned on the base region. The bellows lift 222 is a soft-walled inflatable device which may be made from similar materials to the cradle. In the present embodiment, the bellows is in the form of a square-sided ring having a plurality of inflatable sections 224, 226, 228, three in this case. Each section 224, 226, 228 is independently inflatable and has a one-way inlet valve which can be connected to a portable compressor or other source of pressurised gas and a dump valve. Independent inflation of the bellows sections 224, 226, 228 allows for a controlled, sequential inflation of the lift. However, it may be possible to inflate all the bellows sections simultaneously from a single inlet valve in some applications.

The floor-lift device 210 is dimensioned so that an inflated cradle 10′ can be received on the base region 216 between the side bars, with the seat section 14′ resting on the bellows lift 222. A handle 230 is removably mountable to a rear end of the frame for use in manoeuvring the device.

In use, if a patient is lying on the floor and needs to be lifted, the cradle 10, 10′, 10″, 10′″, 10″″ is placed about and underneath them and inflated until they are supported by the inflated cradle in a sitting position, but with the back- support section of the cradle resting on the floor. A method similar to that described above in relation to FIGS. 11 to 15 can be used to place the patient in this position. The floor-lift device 210 is positioned in front of the cradle with the handle removed, the bellows lift 222 un-inflated and the brakes applied. The cradle 10′ with the patient on-board is tilted forwardly until the seat section 14′ is resting on top of the bellows lift 222 in the base region of the frame. The bellows lift 222 is inflated to raise the person to a more comfortable height. The use of a ring-shaped bellows lift 222 with a central recess has the advantage that the person's weight on the seat section 14′ will tend to push the seat section slightly down inside the ring so as to make the structure more stable and reduce the risk of the cradle 10′ accidentally slipping off when the bellows is inflated. The handle 230 can optionally be reattached to the frame either before or after inflation.

If the patient is sufficiently able, they can be assisted to stand once the bellows lift 222 has been inflated to raise them to a suitable height. Alternatively, the patient can be manoeuvred off the lift device directly onto a chair, bed or a mobile transfer unit 110 whilst supported in the cradle.

It can be seen that the various apparatus described herein, including the inflatable cradle 10, 10′, 10″, the roller transfer frame assembly 90, the mobile transfer unit 110, the chair 140 or other furniture item with roller batons, the toileting support 180, and the floor-lift device 210 can be used together in various combinations to form a highly flexible and uniform system for handling patients with minimum training and physical stress. The various parts of the system are relatively low cost and take up little space. However, it should be appreciated that the various apparatus described can also be used independently of one another or with only some of the other apparatus described. For example, the inflatable cradle 10, 10′, 10″, 10′″, 10″″ can be used independently of the other apparatus to stably and safely support a person for transfer and handling by any suitable means. Other parts of the system, including the roller transfer assembly 90, the mobile transfer unit 110, the chair 140 with roller batons, and the toileting support 180 could all be used, individually or in various combinations, to assist in moving patients without the use of an inflatable cradle 10, 10′, 10″. The patient may, for example, be supported in an alternative supporting structure for movement across the rollers in the various apparatus. This might take the form of a simple seat where the patient has sufficient upper body strength. In view of the above, any of the apparatus and methods of use described herein may be claimed independently of any others.

Whilst use of the inflatable cradle 10′ in accordance with the second embodiment has been described in conjunction with the roller transfer frame assembly 90, the mobile transfer unit 110, the chair 140 with roller batons, the toileting support 180, and the floor-lift device 210, it will be appreciated that the cradle 10, 10′, 10″, 10′″, 10″″ in accordance with any of the embodiments can be used in a similar manner with these apparatus.

Where the terms “comprise”, “comprises”, “comprised” or “comprising” are used in this specification, they are to be interpreted as specifying the presence of the stated features, integers, steps or components referred to, but not to preclude the presence or addition of one or more other feature, integer, step, component or group thereof.

The above embodiments are described by way of example only. Many variations are possible without departing from the scope of the invention.

1. A method of handling a patient using apparatus including an inflatable patient transfer cradle, the cradle when inflated defining a self-supporting seat structure capable of holding a patient seated in the inflated cradle in an upright sitting position for transfer; the cradle having an inflatable seat section, an inflatable back-support section, and a pair of opposed inflatable side panel sections, each inflatable section comprising a soft-walled inflatable body which is flexible when un-inflated; the method comprising:
a. positioning the un-inflated cradle about a patient with the seat section located beneath the patient's upper thigh/buttock region and the back-support section about the patient's back;
b. subsequently inflating the cradle to define said seat structure about the patient.

2. A method as claimed in claim 1, wherein when the cradle is configured so that when inflated to define said seat structure and in an upright position, the back-support section extends upwardly from the seat section with the side panel sections extending between and connected to the back-support section and the seat section on respective sides to define with the back-support section a volume within which the upper body of a patient sitting on the seat section is supported and held generally upright by the back-support section and the side panel sections, the side panel sections being operative to hold the back-support section extending upwardly from the seat section in a self-supporting manner.

3. A method as claimed in claim 1 or claim 2, wherein the un-inflated cradle is positioned about a patient sitting upright on a supporting surface, the seat section being located between the patient's upper thigh/buttock region and the supporting surface, the patient's upper thigh/buttock region being lifted above the surface as the seat section is subsequently inflated.

4. A method as claimed in claim 1 or claim 2, wherein the un-inflated cradle is positioned about a patient lying on a supporting surface, the method comprising:
a. positioning the un-inflated seat section and back-support section between the patient and the supporting surface on which they are lying and placing the patient in a supine position with the back-support section located beneath the patient's back and the seat section located beneath the patient's upper thighs;
b. subsequently inflating the cradle such that the patient is drawn into a sitting position as the cradle inflates to define said seat structure.

5. A method as claimed in claim 4, wherein the seat section, the back-support section and the side panel sections each have an inner surface which is directed toward a patient when sitting in the inflated cradle in use and an opposing outer surface which is directed away from the patient, the method in step a of claim 4 comprising positioning the seat section and the back-support section extending generally in a common plane on the supporting surface with their outer surfaces directed toward the supporting surface and their inner surfaces directed toward the patient; the seat section and the back-support section being drawn into a configuration in which their outer surfaces extend an angle to one another as the cradle inflates to define said seat structure, with the inner surface of the back-support section being directed toward and supporting the patient's back.

6. A method as claimed in claim 4 or claim 5, the method comprising inflating the cradle such that the outer surface of the back-support section remains in contact with the supporting surface and the seat section is drawn into a position in which its outer surface extends generally upwardly from the supporting surface as the cradle is inflated to define said seat structure, the method further comprising tipping the inflated cradle with the patient on-board forwardly on to the outer surface of the seat section so as to raise the back-support section off the supporting surface and place the patient in an upright sitting position supported in the inflated cradle.

7. A method as claimed in claim 4 or claim 5, wherein the method comprises holding the outer surface of the seat section in contact with the supporting surface as the cradle is inflated such that the outer surface of the back-support section is drawn off the supporting surface to automatically raise the patient into an upright sitting position as the cradle inflates to define the seat structure.

8. (canceled)

9. A method as claimed in claim 1, wherein each side panel section is releasably attachable to at least one of the seat section and the back-support section, and wherein the step of positioning the un-inflated cradle about the patient is carried out with the cradle in an un-assembled configuration in which at least one side panel section is disconnected from at least one of the seat section and the back-support section; the un-inflated cradle being placed in an assembled configuration in which each side panel is connected to both the seat section and the back-support section prior to the step of inflating the cradle.

10. (canceled)

11. A method as claimed in claim 9, wherein each side panel section is releasably attachable to both the seat section and the back-support section and wherein at least one side panel is disconnected from both the seat section and the back-support section when the cradle is in its un-assembled configuration for positioning about the patient.

12. (canceled)

13. (canceled)

14. A method as claimed in claim 1, the cradle having at least two separable parts releasably attachable to one another, the at least two separable parts including a first part comprising at least the back-support section and a second part comprising at least the seat section, each side panel section extending between and connected to the back-support section and a respective side of the seat section when the at least two parts are assembled; wherein the step of positioning the un-inflated cradle about a patient comprises positioning the un-inflated cradle about the patient with the at least two parts separated and subsequently connecting the at least two parts together prior to the step of inflating the cradle.

15. A method as claimed in claim 14, wherein the step of positioning the un-inflated cradle about a patient comprises positioning the seat section and the back-support section between a patient and a surface on which they are lying and placing the patient in a supine position such that the back-support section is located beneath and its inner surface directed towards the patient's back and the seat section is located beneath the patient's upper thighs and connecting the at least two parts of the cradle together whilst the patient remains in a supine position prior to the step of inflating the cradle.

16. A method as claimed in claim 1, wherein the cradle is configured to be inflated to a pressure of at least 27 kPa or more preferably at least 34 kPa.

17. A method as claimed in claim 1, wherein with a patient supported in the inflated cradle and the cradle in an upright position, the method comprises manoeuvring the inflated cradle with a patient on-board across a surface.

18. A method as claimed in claim 1, the method comprising:
a. supporting a patient in the inflated cradle in an upright sitting position on a first supporting structure;
b. moving the cradle from the first supporting structure onto a second supporting structure whilst the patient is supported in an upright sitting position within the inflatable cradle during said movement.

19. (canceled)

20. (canceled)

21. (canceled)

22. (canceled)

23. (cancelled)

24. (cancelled)

25. (cancelled)

26. Apparatus for use in the method of claim 1, the apparatus comprising an inflatable patient transfer cradle which when inflated defines a self-supporting seat structure capable of holding a patient seated in the inflated cradle in an upright sitting position for transfer between different locations; the cradle comprising an inflatable seat section, an inflatable back-support section, and a pair of opposed inflatable side panel sections, each inflatable section comprising a soft-walled inflatable body which is flexible when un-inflated.

27. Apparatus as claimed in claim 26, wherein the cradle is configured such that when inflated to define said seat structure and placed in an upright position on the seat section, the back-support section extends upwardly from the seat section with the side panel sections extending between and connected to the back-support section and the seat section on respective sides to define with the back-support section a volume within which the upper body of a patient sitting on the seat section can be supported and held generally upright by the back-support section and the side panel sections, the side panel sections being operative in use to hold the back-support section extending upwardly from the seat section to support the weight of a patient's upper body in a self-supporting manner.

28. Apparatus as claimed in claim 26, wherein each side panel section is releasably attachable to at least one of the seat section and the back-support section.

29. Apparatus as claimed in claim 28, wherein each side panel section is releasably attachable to both the seat section and the back-support section.

30. (canceled)

31. (canceled)

32. Apparatus as claimed in claim 26, wherein the cradle has at least two separable parts releasably attachable to one another, a first part comprising at least the back-support section and a second part comprising at least the seat section, each side panel section extending between and connected to the back-support section and a respective side edge of the seat section when the at least two parts are assembled.

33. Apparatus as claimed in claim 32, wherein the side panel sections are permanently attached to one of the seat section and the back-support section and are releasably connectable to the other of the seat section and the back-support section to attach the first and second parts together, the cradle comprising a plurality of releasable fasteners for releasably connecting each side panel section to said other of the seat section and the back-support section.

34. (canceled)

35. (canceled)

36. (canceled)

37. Apparatus as claimed in claim 26, wherein the cradle is configured to be inflated to a pressure of at least 27 kPa or more preferably at least 34 kPa.

38. Apparatus as claimed in claim 26, wherein the seat section is profiled to define a central recess along a rear edge of the seat section and the back-support section is profiled to define a central recess along a bottom edge.

39. (canceled)

40. Apparatus as claimed in claim 26, wherein the seat section defines a toileting aperture.

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)
